(19) United States
(12) Patent Application Publication
(10) Pub. No.: US 2025/0372105 A1
(43) Pub. Date: Dec. 4, 2025

(54) AUDIO SIGNAL REPRESENTATION DECODING UNIT AND AUDIO SIGNAL REPRESENTATION ENCODING UNIT

(71) Applicant: Fraunhofer-Gesellschaft zur Förderung der angewandten Forschung e.V., Munchen (DE)

(72) Inventors: Christoph HOLD, Helsinki (FI); Dominik WECKBECKER, Erlangen (DE); Markus MULTRUS, Erlangen (DE); Archit TAMARAPU, Erlangen (DE); Andrea EICHENSEER, Erlangen (DE); Anika TREFFEHN, Erlangen (DE); Guillaume FUCHS, Erlangen (DE); Oliver THIERGART, Erlangen (DE)

(21) Appl. No.: 19/302,468

(22) Filed: Aug. 18, 2025

Related U.S. Application Data
(63) Continuation of application No. PCT/EP2024/054279, filed on Feb. 20, 2024.

(30) Foreign Application Priority Data
Feb. 23, 2023 (WO) PCT/EP2023/054622

(51) Int. Cl. G10L 19/008; H04S 7/00

(52) U.S. Cl. CPC G10L 19/008; H04S 7/30; H04S 2420/11

(57) ABSTRACT

An audio signal representation decoding unit for generating a decompressed ambisonic spatial audio signal representation from a compressed ambisonic spatial audio signal representation representing an audio signal, including: sector decoding paths, each configured to decode a directional sector signal of the decompressed ambisonic spatial audio signal representation in each spatial sector by applying, to at least one transport channel, or a sector signal derived from the at least one transport channel, directional parameter(s) and a sector diffuseness parameter(s) of a spatial sector, a global diffuseness signal decoding path to derive a global diffuseness signal by applying, to the at least one transport channel, a global diffuseness parameter, or other information on the global diffuseness of the audio signal, a global diffuseness signal inserter to combine decoded directional sector signals and the global diffuseness signal, to output the decompressed ambisonic spatial audio signal representation.

### CROSS-REFERENCES TO RELATED APPLICATIONS

This application is a continuation of copending International Application No. PCT/EP2024/054279, filed Feb. 20, 2024, which is incorporated herein by reference in its entirety, and additionally claims priority from International Application No. PCT/EP2023/054622, filed Feb. 23, 2023, which is incorporated herein by reference in its entirety.

### BACKGROUND OF THE INVENTION

The present document refers to an audio signal representation decoding unit, an audio signal representation encoding unit, apparatuses comprising them, and methods and non-transitory storage units.

This document details a novel structure for higher-order directional audio coding (HO-DirAC) for higher-order Ambisonics (HOA) input to output transmission. This document is also directed to a Sector-based DirAC system with combined first- and higher-order DoA and diffuseness estimation.

According to standard, conventional ambisonic audio signal representations, there is one single direction of arrival (DoA), and one single diffuseness for the whole space. However, it has been understood that it is possible to have multiple DoAs and diffuseness in multiple spatial sectors. Therefore, a different, more accurate sound field parameter model is here proposed.

In contrast to commonly employed first-order parameter estimators, there is made use of the additional information available in the higher-order channels of HOA. Specifically, the sound-field may be characterized by more than one dominant direction of arrival (DoA), which enables resolving more than one sound source per critical band at the encoder.

At the decoder, these additional DoAs control the synthesis of multiple directional HOA streams that may originate from multiple sound-sources.

Despite the additional information, the proposed technique may implement the current coder structure, preserving the robustness of the current first-order Ambisonic (FOA) DirAC, enabling seamless switching between both designs for different coding scenarios.

In essence, the proposed technique improves upon previously known HO-DirAC methods by making use of sector-local and global diffuseness information. Specifically, the new technique is able to more accurately model realistic sound scenes by correctly and robustly reproducing the global diffuse energy ratio of the input signal, resulting in an improved perceptual quality during HOA audio coding and spatial enhancement over the previous designs.

This is because the global diffuseness path resembles that of a first-order system, therefore keeping its relative robustness and stability. At the same time, a higher accuracy of the spatial image can be obtained by measuring a DoA for each sector of an arbitrary number of sectors and reconstructing multiple directional components of the sound field.

In addition, the integration of multiple DoAs into existing first-order DirAC systems is strongly simplified with the present invention.

Directional Audio Coding parameterizes a spatial audio scene as perceptually relevant parameters. These parameters comprise, for each time-frequency tile, the direction of arrival (DoA) Ω of the incidence sound-field and a sound-field diffuseness measure Ψ, indicating the ratio between directional and diffuse sound field components. Both parameters are extracted from the active intensity vector, estimated from first-order Ambisonics (FOA) (see [US20100169103A1]). The active intensity vector i is conveniently derived from FOA, according to the well-known formula (cf. [Pulkki2007]),

$$i = p v .$$

The direction of i gives a DoA estimate, while the length compared to the acoustic energy gives a diffuseness measure.

The decoder may restore certain higher-order signal components from transmitted FOA signals, as detailed in a HO-DirAC Coder Patent [WO 2020/115311 A1]. According to WO 2020/115311 A1, input FOA signals are split into two rendering paths based on estimated diffuseness Ψ; to perform directional (i.e. 1−Ψ) and diffuse (Ψ) rendering. The directional components are assumed to be plane waves and thus decoded as HOA signals in direction of Ω, by a plane-wave continuation of the omni-directional pressure signal x₀₀. The latter is extracted from the transmitted subset signal. Diffuse components result in FOA signals, scaled by a function that depends on Ψ.

HOA signals allow segmenting the input sound-field, e.g. by multiple spatial weightings, i.e. beamformer(s), as those in FIG. 3. HOA input thus allows formulating accordingly weighted FOA signals, as shown in FIG. 4. Therefore, these segmented FOA channels, i.e. sound-field sectors, allow simultaneous estimation of multiple (2 and Y on sound-field sectors. (as in HO-DirAC Sector Processing [U.S. Pat. No. 10,313,815 B2]).

Sector parameters have been proposed in [Politis2015], however, not for spatial audio coding and compression but for loudspeaker-based rendering and spatial sharpening.

An apparatus of the prior art transmits a single DoA and diffuseness (first-order estimates Ψ, Ω), or partially recovers these estimates at the decoder.

The current, conventional sound-field model assumes a mix of a single directional source and a diffuse sound-field, per time-frequency tile. However, this conventional model is often violated in practice, e.g. by multiple directional sources in the same time-frequency tile, or by specular reflections. A multi-DoA model, such as the proposed sector model, can resolve such scenarios for multiple directional sound-sources, thus increasing perceived audio quality.

Furthermore, the sector-based model can stabilize the parameter estimation in situations with competing directions; the sector weighting biases the DoA estimator, leading to less directional fluctuation, thus, stabilizing and improving performance. In general, this technique improves rendering situations consisting of very spatial and directional sound events.

Combining the use of first-order (global) and higher-order (directionally local) sound-field diffuseness estimate during rendering can increase performance in a coding framework. This is because the diffuseness level is critical to the rendering impression, as it distributes signal energy between the directional and the diffuse rendering stream, see FIG. 5a (block Ψ). The spatially averaged global diffuseness captures this feature of the sound scene accurately and with a good stability and may, therefore, provide better perceptual quality in practice.

Lower bitrate scenarios only allow to transmit a single (first-order) set of estimates, therefore, switching to higher bitrates and enabling the proposed architecture should not rebalance the direct-to-diffuse ratio of the rendered HOA signals. This is avoided by utilizing the global diffuseness Ψ for balancing the global direct-to-diffuse ratio. The directionally local sector diffuseness is then utilized to balance the local sector directional re-encoding.

The combination of global diffuseness and sector diffuseness also enables diffuseness-dependent bit savings in the metadata, e.g., by limiting the quantization steps of the directional parameters for sectors which have predominantly diffuse contents. In sound-scenes with high Ψ only little energy is distributed to the directional stream, thus requiring only coarse quantization of the directional parameterization.

Furthermore, FOA can be assumed to be sufficiently restored at the decoder for sufficient bit-rate, which allows to recover first order estimates at decoder. This comprises in particular Ψ, therefore, no transmission is needed.

FIG. 2 shows an example related to the prior art. It can be seen that a FOA (first order ambisonic) signal 202 is split at signal splitter 204 between one single directional path 221 and a global diffuseness path 205. The signal splitter 204 is conditioned by a global diffuseness Ψ of the FOA signal 202 (or, in alternative, to a complement to the global diffuseness Ψ of the FOA signal 202, which may be 1−Ψ). At the signal splitter 204, the FOA signal 202 is scaled by a weight which is in accordance to the directionality of the signal (1−Ψ). At block 224, an omni-directional pressure x₀₀ is applied to the FOA, to obtain a resulting directional signal 226. The directional signal 226 is also transformed at block 228, by applying a spherical harmonic function of a DoA (Ω). At the splitter 204, the signal splitter 204 also outputs a global diffuseness signal 210, which is routed to a second path 205, e.g. by weighting the FOA signal 202 by a weight conditioned by Ψ. At an energy compensator (208) (cf. WO 2020/115311 A1), the global diffuseness signal 210 is obtained. At block 260, the global diffuseness signal 210 and the direction signal 222 are added with each other to obtain a HOA signal 262. The DoA Q and the global diffuseness Ψ are obtained from the bitstream.

It is intended to have a more to more accurately model realistic sound scenes by resolving simultaneous multi-source scenarios, resulting in improved perceptual quality during HOA audio coding and spatial enhancement over the current design.

### SUMMARY

An embodiment may have an audio signal representation decoding unit for generating a decompressed ambisonic spatial audio signal representation from a compressed ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the audio signal representation decoding unit including a plurality of sector decoding paths, each sector decoding path being configured to decode a directional sector signal of the decompressed ambisonic spatial audio signal representation in each spatial sector by applying, to the at least one transport channel, or a sector signal derived from the at least one transport channel, the directional parameter(s) and the sector diffuseness parameter(s) of the spatial sector,
the audio signal representation decoding unit including a global diffuseness signal decoding path configured to derive a global diffuseness signal by applying, to the at least one transport channel, a global diffuseness parameter, or other information on the global diffuseness of the audio signal,
the audio signal representation decoding unit including a global diffuseness signal inserter to combine the plurality of decoded directional sector signals and the global diffuseness signal, to output the decompressed ambisonic spatial audio signal representation.

Another embodiment may have an apparatus, comprising:
the audio signal representation decoding unit according to the invention;
a bitstream reader and dequantizer, configured to read a bitstream, in which there is encoded the low order spatial audio signal representation, and to provide the high order spatial audio signal representation to the audio signal representation decoding unit.

Another embodiment may have an audio signal representation encoding unit for encoding an input spatial audio signal representation, representing an audio signal, onto a compressed ambisonic spatial audio signal representation representing the audio signal,
the audio signal representation encoding unit being configured to downmix the input spatial audio signal representation to derive at least one transport channel;
the audio signal representation encoding unit being configured to derive side information, the side information including sound field parameters, the sound field parameters including, for each spatial sector of a plurality of spatial sectors, directional parameter(s) providing information on a direction of arrival, DoA, in the spatial sector, the sound field parameters including sector diffuseness parameter(s) providing information on diffuseness of the audio signal in at least one spatial sector,
the audio signal representation encoding unit including a plurality of sector parameter estimators, each sector parameter estimator being configured to process a specific sector signal of the input spatial audio signal representation in a specific spatial sector of the plurality of spatial sectors, so as to derive the directional parameter(s) and the information on diffuseness of the audio signal in the at least one spatial sector,
the audio signal representation encoding unit including a bitstream writer to encode the at least one transport channel and the side information.

Another embodiment may have an audio encoder comprising:
the audio signal representation encoding unit according to the invention;
a quantizer and bitstream writer for writing, in a bitstream, a low order spatial audio signal representation and/or the compressed ambisonic spatial audio signal representation.

Another embodiment may have an method for decompressing an ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the method including using a plurality of sector decoding paths, each sector decoding path decoding a directional sector signal of the ambisonic spatial audio signal representation in each spatial sector by applying, to the at least one transport channel, or a sector signal derived from the transport channel, the directional parameter(s) and the sector diffuseness parameter(s) of the spatial sector,
the method including using a global diffuseness signal decoding path to derive a global diffuseness signal by applying, to the at least one transport channel, a global diffuseness parameter, or other information on the global diffuseness of the audio signal,
the method including combining, through a global diffuseness signal inserter, the plurality of decoded directional sector signals and the global diffuseness signal, to output the decompressed ambisonic spatial audio signal representation.

Another embodiment may have an method for encoding an input spatial audio signal representation, representing an audio signal, onto a compressed ambisonic spatial audio signal representation representing the audio signal,
the method including deriving at least one transport channel and side information, the side information including sound field parameters, the sound field parameters including, for each spatial sector of a plurality of spatial sectors, directional parameter(s) providing information on a direction of arrival, DoA, in the specific spatial sector, the sound field parameters including sector diffuseness parameter(s) providing information on diffuseness of the audio signal in at least one spatial sector,
the method including using a plurality of sector parameter estimators, each sector parameter estimator processing a specific sector signal of the input spatial audio signal representation in a specific spatial sector of the plurality of spatial sectors, so as to derive the directional parameter(s) and the information on diffuseness of the audio signal in the at least one spatial sector,
the method including using an encoding of the at least one transport channel and the side information into a bitstream.

Another embodiment may have an non-transitory digital storage medium having a computer program stored thereon to perform the method for decompressing an ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the method including using a plurality of sector decoding paths, each sector decoding path decoding a directional sector signal of the ambisonic spatial audio signal representation in each spatial sector by applying, to the at least one transport channel, or a sector signal derived from the transport channel, the directional parameter(s) and the sector diffuseness parameter(s) of the spatial sector,
the method including using a global diffuseness signal decoding path to derive a global diffuseness signal by applying, to the at least one transport channel, a global diffuseness parameter, or other information on the global diffuseness of the audio signal,
the method including combining, through a global diffuseness signal inserter, the plurality of decoded directional sector signals and the global diffuseness signal, to output the decompressed ambisonic spatial audio signal representation,
when said computer program is run by a computer.

Another embodiment may have an non-transitory digital storage medium having a computer program stored thereon to perform the method for encoding an input spatial audio signal representation, representing an audio signal, onto a compressed ambisonic spatial audio signal representation representing the audio signal,
the method including deriving at least one transport channel and side information, the side information including sound field parameters, the sound field parameters including, for each spatial sector of a plurality of spatial sectors, directional parameter(s) providing information on a direction of arrival, DoA, in the specific spatial sector, the sound field parameters including sector diffuseness parameter(s) providing information on diffuseness of the audio signal in at least one spatial sector,
the method including using a plurality of sector parameter estimators, each sector parameter estimator processing a specific sector signal of the input spatial audio signal representation in a specific spatial sector of the plurality of spatial sectors, so as to derive the directional parameter(s) and the information on diffuseness of the audio signal in the at least one spatial sector,
the method including using an encoding of the at least one transport channel and the side information into a bitstream,
when said computer program is run by a computer.

Another embodiment may have a compressed ambisonic audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector, and a global diffuseness parameter.

In accordance to an aspect, there is provided an audio signal representation decoding unit for generating a decompressed ambisonic spatial audio signal representation from a compressed ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the audio signal representation decoding unit including a plurality of sector decoding paths, each sector decoding path being configured to decode a directional sector signal of the decompressed ambisonic spatial audio signal representation in each spatial sector by applying, to the at least one transport channel, or a sector signal derived from the at least one transport channel, the directional parameter(s) and the sector diffuseness parameter(s) of the spatial sector,
the audio signal representation decoding unit including a global diffuseness signal decoding path configured to derive a global diffuseness signal by applying, to the at least one transport channel, a global diffuseness parameter, or other information on the global diffuseness of the audio signal,
the audio signal representation decoding unit including a global diffuseness signal inserter to combine the plurality of decoded directional sector signals and the global diffuseness signal, to output the decompressed ambisonic spatial audio signal representation.

In some examples, the at least one transport channel may actually include (or at least may be processed, e.g. by upmixing, to obtain) a plurality of transport channels. For example, the at least one transport channel may actually include a plurality of transport channels upmixed from a first number of transport channels (which may be 1 or a plural number) to a second number of transport channels (the second number of transport channels being greater than the first number of transport channels, and therefore being always a plural number). Therefore, even if the bitstream includes one single transport channel (or a certain number of transport channels), in some examples the audio signal representation decoding unit may process the one single transport channel (or a certain number of transport channels) to obtain an upmixed plural number (greater than the certain number of transport channels). Subsequently, the directional paths and the global diffuseness signal decoding path are applied to the upmixed plural transport channels in plural number.

According to an aspect, the audio signal representation decoding unit is configured to apply, to the at least one transport channel or a sector signal derived from the transport channel, the sector diffuseness parameter(s) by weighting the transport channel, in at least one sector decoding path, using a mixing weight derived from the sector diffuseness parameter(s), to thereby derive the directional sector signal.

According to an aspect, the audio signal representation decoding unit is configured to weight the at least one transport channel or sector signal derived from the transport channel using the mixing weight being, or being derived from, a positive coefficient received from, or processed from, the sector diffuseness parameter(s).

According to an aspect, the audio signal representation decoding unit is configured to weight the at least one transport channel, or sector signal derived from the transport channel, using the mixing weight, for at least one spatial sector,
the mixing weight being, or being derived from, a coefficient indicative of a sector directionality in the specific spatial sector.

According to an aspect, the audio signal representation decoding unit is configured to weight the at least one transport channel or sector signal derived from the transport channel using the mixing weight, for each spatial sector,
the mixing weight being, or being derived from, a coefficient indicative of the relative directionality of the signal in the specific spatial sector over the relative directionalities of the totality of the spatial sectors.

According to an aspect, the audio signal representation decoding unit is configured to weight the at least one transport channel or sector signal derived from the transport channel for at least one first spatial sector using a first mixing weight being, or being derived from, a coefficient indicative of the sector directionality in the first spatial sector, and
configured to weight the at least one transport channel or sector signal derived from the transport channel for at least one second spatial sector using a second mixing weight,
the audio signal representation decoding unit being configured to retrieve the second mixing weight being retrieved by complementing, to a predetermined fixed value, the coefficient indicative of the sector directionality in the first spatial sector.

According to an aspect, the audio signal representation decoding unit is configured to derive each of (N−1)-th mixing weights from parameters written in the side information, and to derive one N-th mixing weight from by complementing the other (N−1)-th mixing weights to a constant positive value, where N is the number of spatial sectors.

According to an aspect, the decoding unit is configured, in each sector decoding path, to apply, to the at least one sector signal, the directional parameter(s) by multiplying the at least one sector signal by a vector of spherical harmonic functions evaluated along the DoA (Ωₛ) in the spatial sector, so as to extend the directional signal for the spatial sector in a higher ambisonics order.

According to an aspect, the decoding unit is configured to apply a spatial filter to the at least one transport channel or processed version of the at least one transport channel, to limit the at least one transport channel to one spatial sector for each sector decoding path.

According to an aspect, the decoding unit is configured to compute at least one directional sector signal using

$${x}_{s} = {x}_{s} * Y ( {Ω}_{s} ) = [ {x}_{s} * {Y}_{00} ( Ω ) , {x}_{s} * {Y}_{1 - 1} ( Ω ) , {x}_{s} * {Y}_{10} ( Ω ) , {x}_{s} * {Y}_{11} ( Ω ) , … ] ,$$

where s indicates the spatial sector, xₛ is the transport channel, or processed version thereof, in the specific spatial sector s, Ωₛ is the directional parameter for the specific spatial sector s, and Y, which is a function of Ωₛ, is the vector of spherical harmonic functions given by [Y₀₀(Ωₛ), Y₁₋₁(Ωₛ), Y₁₀(Ωₛ), Y₁₁(Ωₛ), . . . Yₙₘ(Ωₛ)], and Yₙₘ (Ωₛ) is a spherical harmonic of order n and degree m.

According to an aspect, the decoding unit of any of the preceding aspects, configured to compute at least one directional sector signal for at least the specific spatial sector using

$${x}_{H , s} = ( 1 - Ψ ) * {a}_{s} * Y ( {Ω}_{s} ) * {x}_{s}$$

where Ψ is the global diffuseness parameter, aₛ is the sector diffuseness parameter expressed as relative sector directionality in the at least one sector signal, Y(Ω) is a vector of spherical harmonic functions evaluated along the DoA Ωₛ in the specific spatial sector.

According to an aspect, the decoding unit is configured to read the global diffuseness parameter from the side information.

According to an aspect, the decoding unit is configured to estimate the global diffuseness parameter from the at least one transport channel.

According to an aspect, the decoding unit is configured to apply a global diffuseness weight obtained from the global diffuseness parameter, or the information on the global diffuseness of the audio signal, to weight the at least one transport channel, thereby obtaining a global diffuseness signal version to be used in the global diffuseness signal decoding path, and
to apply a second weight, complementary to the global diffuseness weight, to weight the at least one transport channel, thereby obtaining at least one globally non-diffuse signal to be processed in the plurality of sector decoding paths.

According to an aspect, the decoding unit is configured to derive mixing weight(s) of the global diffuseness signal and the directional sector signals from the global diffuseness parameter, or the information on the global diffuseness of the audio signal.

According to an aspect, the decoding unit is configured to apply, to the at least one transport channel, a weighting parameter complementary to the global diffuseness parameter used for deriving the global diffuseness signal, so that, for each sector decoding path, the at least transport channel is weighed using the weighting parameter.

According to an aspect, the global diffuseness signal decoding path is configured to weight the at least one transport channel by a global diffuseness gain, which is, or is derived from, the global diffuseness parameter, or the other information on the global diffuseness of the audio signal, and
each of the plurality of sector decoding paths is configured to weight the at least one transport channel by a global directionality gain which is, or is derived from, the global diffuseness parameter, or the other information on the global diffuseness of the audio signal.

According to an aspect, the global diffuseness gain is 1+g(Ψ) and is according to

$$1 + g ( Ψ ) = \sqrt{1 + Ψ * ( \frac{H + 1}{L + 1} - 1 )} ,$$

where Ψ is, or is derived from, the global diffuseness parameter, or the other information on the global diffuseness of the audio signal, L is an ambisonic input order and H is an ambisonic output order.

According to an aspect, the global diffuseness gain is 1+g(Ψ) and is according to

$$1 + g ( Ψ ) = \sqrt{1 + Ψ * ( {f}_{comp} - 1 )} ,$$

where Ψ is, or is derived from, the global diffuseness parameter, or the other information on the global diffuseness of the audio signal, and f_{comp} is a diffuse compensation factor.

According to an aspect, the diffuse compensation factor is given by

$${f}_{comp} = \frac{( {\sum }_{l = 0}^{H} {\sum }_{m = - l}^{l} \frac{1}{2 * l + 1} )}{( {\sum }_{l = 0}^{L} {\sum }_{m = - l}^{l} \frac{1}{2 * l + 1} )}$$

where l is the degree of a spherical harmonic and L is the ambisonic order of the input signal and H is a higher ambisonic order, or a signal comprising the transport channels and channels generated via the use of decorrelators, and m is the index of a spherical harmonic and assumes values from −l to l.

According to an aspect, the value range of the global diffuseness gain is limited to a certain value range as to prevent too strong deviations from the global diffuseness signal.

According to an aspect, the global diffuseness signal decoding path includes an energy compensator unit to apply the gain to the global diffuseness signal to adjust the energy distribution as to obtain a more physically realistic ambisonics output signal.

According to an aspect, the audio signal representation decoding unit is configured to switch between:
a low order operation mode, in which, among the plurality of sector decoding paths, at least one of the sector decoding paths is deactivated, while only one of the sector decoding paths is activated, wherein the side information does not contain the sound field parameter(s) for the deactivated at least one of the sector decoding paths; and
a high order operation mode, in which, among the plurality of sector decoding paths, all the plurality sector decoding paths are activated, or at least less sector decoding paths are deactivated in respect to the low order operation mode, wherein the side information also contains the sound field parameter(s) for all the plurality of the sector decoding paths, as well as the global diffuseness parameter.

According to an aspect, the audio signal representation is configured to convert the spatial audio signal representation from an encoded at least one transport channel into a decoded version of the encoded at least one transport channel.

According to an aspect, the audio signal representation comprises an EVS decoder to decoder the encoded at least one transport channel into the decoded version of the encoded at least one transport channel.

According to an aspect, the audio signal representation decoding unit is configured to convert the decoded ambisonic spatial audio signal representation from the filterbank domain to the time domain.

According to an aspect, the audio signal representation decoding unit is configured to upmix the at least one transport channel from a first number of transport channels to a second number of transport channels greater than the first number.

According to an aspect, the audio signal representation decoding unit comprises a mixing-matrix estimator configured to process the sound field parameters, to derive a covariance matrix, or other covariance information, between different transport channels, the mixing-matrix estimator being configured to reconstruct a mixing matrix, or other mixing information, from the covariance matrix, or the other covariance information, and to apply the mixing matrix, or the other mixing information, to the transport channels.

According to an aspect, the mixing-matrix estimator is configured to process the sound field parameter(s) including the DoA parameter(s) and sector diffuseness parameter(s) of the plurality of spatial sectors and the global diffuseness parameter, or other information on the global diffuseness, to derive the covariance matrix, or the other covariance information, between different transport channels, the mixing-matrix estimator being configured to reconstruct a mixing matrix from the covariance matrix, or the other covariance information, so as to employ the sound field parameter(s) to derive the covariance matrix, or the other covariance information, for at least one frequency band, the audio signal representation decoding unit being configured to derive the covariance matrix, or the other covariance information, for at least one other frequency band without using the sound field parameters.

According to an aspect, the audio signal representation decoding unit is configured to derive, for at least one other frequency band, the mixing matrix, or other mixing information, from covariance information which is received from the side information.

According to an aspect, the sound field parameters are modified in order to achieve a rotation of the sound field represented by the output ambisonic signal.

In accordance to an aspect, there is provided an apparatus, comprising:
the audio signal representation decoding unit of any of the preceding aspects;
a bitstream reader and dequantizer, configured to read a bitstream, in which there is encoded the low order spatial audio signal representation, and to provide the high order spatial audio signal representation to the audio signal representation decoding unit.

According to an aspect, the apparatus further comprises
a renderer, to render the audio signal from the ambisonic spatial audio signal representation.

According to an aspect, the apparatus further comprises an encoding unit to encode the high order spatial audio signal representation onto a second spatial audio signal representation.

In accordance to an aspect, there is provided an audio signal representation encoding unit for encoding an input spatial audio signal representation, representing an audio signal, onto a compressed ambisonic spatial audio signal representation representing the audio signal,
the audio signal representation encoding unit being configured to downmix the input spatial audio signal representation to derive at least one transport channel;
the audio signal representation encoding unit being configured to derive side information, the side information including sound field parameters, the sound field parameters including, for each spatial sector of a plurality of spatial sectors, directional parameter(s) providing information on a direction of arrival, DoA, in the spatial sector, the sound field parameters including sector diffuseness parameter(s) providing information on diffuseness of the audio signal in at least one spatial sector,
the audio signal representation encoding unit including a plurality of sector parameter estimators, each sector parameter estimator being configured to process a specific sector signal of the input spatial audio signal representation in a specific spatial sector of the plurality of spatial sectors, so as to derive the directional parameter(s) and the information on diffuseness of the audio signal in the at least one spatial sector,
the audio signal representation encoding unit including a bitstream writer to encode the at least one transport channel and the side information.

According to an aspect, the audio signal representation encoding unit includes a global diffuseness parameter estimator to estimate a global diffuseness parameter to be inserted in the side information.

According to an aspect, the audio signal representation encoding unit is configured to refrain from writing, in the bitstream, a global diffuseness parameter.

According to an aspect, the audio signal representation encoding unit is configured to estimate a relative directionality of each specific spatial sector in respect to the directionalities of the all spatial sectors, and to write (e.g. in the side information) the coefficient (e.g. indicated as a₁, a₂, etc. here below, and which may be mixing weights), or information indicative of the relative directionality, as a sector diffuseness parameter (e.g. one sector diffuseness parameter for each spatial sector of the plurality of spatial sectors, or one sector diffuseness parameter for at least one of the plurality of spatial sectors, such as one sector diffuseness parameter for each of all but one of the plurality of spatial sectors).

In some examples, it is possible to write (e.g. in the side information) each coefficient (a₁, a₂, etc.), or information indicative of the relative directionality, for each sector diffuseness parameter. In some examples, all but one coefficients, or information indicative of the relative directionality, are written (e.g. in the side information), while one single coefficient, or information indicative of the relative directionality, is skipped: since the sum of the coefficients (or information indicative of the relative directionality) may be known (e.g., 1), it is possible to skip one of the coefficients, while the decoder can reconstruct it. For example, it may be that a₂+a₁=1, and therefore it is possible to simply write, as side information, a₁, while the audio signal representation decoding unit may derive a₂ from a₂=1−a₁. Therefore, while in some examples the side information may include all the coefficients, in some other examples there may be at least one coefficient written (e.g. only a₁), and at least one coefficient may be obtained from the first one (e.g. as a₂=1−a₁).

According to an aspect, the audio signal representation encoding unit is configured to estimate the relative directionality as including at least one of a first and a second spatial sector respectively indicated with a₁ and a₂ and satisfies

$${a}_{1} = \frac{1 - {Ψ}_{1}}{( 1 - {Ψ}_{1} ) + ( 1 - {Ψ}_{2} )}$$

$$and$$

$${a}_{2} = 1 - {a}_{1} ,$$

where Ψ₁ is, or is obtained from, the sector diffuseness information for the first spatial sector and Ψ₂ is, or is obtained from, the sector diffuseness information for the second spatial sector.

According to an aspect, the audio signal representation encoding unit is configured to estimate the relative directionality to include two or more sectors according to

$${a}_{i} = \frac{1 - {Ψ}_{i}}{{\sum }_{j} ( 1 - {Ψ}_{j} )}$$

$$with$$

$${\sum }_{j} {a}_{j} = 1 ,$$

where i indicates the i-th, specific, spatial sector, and j indicates a generic j-th spatial sector of the plurality of spatial sectors, Ψᵢ and Yⱼ indicate the sector diffuseness information for the i-th, specific, spatial sector, and each j-th generic spatial sector.

According to an aspect, the audio signal representation encoding unit is configured to perform an active downmix of the audio signal, or a processed version thereof, using a downmix matrix, or other downmix information, computed by a downmix information calculator, the downmix information calculator being configured to process the sound field parameter(s) to derive the downmix matrix, or other downmix information, based on the global diffuseness parameter and sector diffuseness parameter(s) and directional parameter(s) for each spatial sector of the plurality of spatial sector.

According to an aspect, the information matrix calculator is configured to perform an inter-channel prediction to derive the downmix matrix, or other downmix information, based on an inter channel covariance matrix, or other inter channel covariance information, the inter channel covariance matrix or other inter channel covariance information being derived from the directional parameter(s) and sector diffuseness parameter(s) for each spatial sector of the plurality of sectors and a global diffuseness.

According to an aspect, the inter channel covariance matrix C being defined as having the element C_{lm,l′m′} between the ambisonic channel with the degree and index l and l′, respectively, and the ambisonic channel with the degree and index l′ and m′, respectively, and being computed according to

$${C}_{lm , {l}^{′} {m}^{′}} = ( 1 - Ψ ) * {E}_{x} * {a}^{2} * {Y}_{l m} ( {Ω}_{1} ) * {Y}_{{l}^{′} {m}^{′}} ( {Ω}_{1} ) + ( 1 - Ψ ) * {E}_{x} * {( 1 - a )}^{2} * {Y}_{l m} ( {Ω}_{2} ) * {Y}_{{l}^{′} {m}^{′}} ( {Ω}_{2} ) ++ Ψ * {σ}^{2} * {E}_{x} * {δ}_{lm , {l}^{′} {m}^{′}}$$

where Eₓ is the signal energy, δ_{lm,l′m′} is the Kronecker delta being 1 at the diagonal of the inter channel covariance matrix and 0 outside the diagonal of the inter channel covariance matrix, Ω₁ and Ω₂ are the first and second directional parameters, respectively, and “a” is a relative directionality, or another parameter indicative of a ratio, or another information on relationship, between the directionality in the spatial sector over the total directionalities of the totality of the spatial sectors, Ψ is indicative of the global diffuseness parameter, and o is an energy scaling factor.

According to an aspect, the inter-channel covariance matrix or other inter-channel covariance information is based on an energy weighted by the spherical harmonics evaluated at the DoAs (Ω₁, Ω₂, . . . , Ω_{N}) and mixing weights (a₁, a₂, . . . , a_{N}) for each spatial sector.

According to an aspect, the audio signal representation encoding unit is further configured to convert the input spatial audio signal representation into the filterbank domain to derive a filterbank version of the input spatial audio signal representation,
further configured to downmix the filterbank domain version of the input spatial audio signal representation to derive the at least one transport channel in the filterbank domain, and
further configured to perform a filterbank synthesis of the at least one transport channel from the filterbank domain time domain.

According to an aspect, the audio signal representation encoding unit is configured to downmix the input spatial audio signal representation using a channel selector to derive the at least one transport channel by selecting lower order channels from higher order channels of the input spatial audio signal representation.

According to an aspect, the audio signal representation encoding unit is further configured to perform an enhanced voice services, EVS, encoding, so as to provide an EVS-encoded version of the at least one transport channel.

In accordance to an aspect, there is provided the audio signal representation encoding unit configured to switch between:
a low order operation mode, in which, among a plurality of sector paths (e.g. sector encoding paths), at least one of the sector paths is deactivated, while only one of the sector paths is activated, wherein the side information does not contain the sound field parameter(s) for the deactivated at least one of the sector paths; and
a high order operation mode, in which, among the plurality of sector paths, all the plurality sector paths are activated, or at least less sector paths are deactivated in respect to the low order operation mode, wherein the side information also contains the sound field parameter(s) for all the plurality of the activated sector paths, as well as a global diffuseness parameter.

In accordance to an aspect, the audio signal representation encoding unit may be configured to select between the low order operation mode and the high order operation mode based on the bitrate, so as to select the low order operation mode in case of low bitrate, and the high order operation mode in case of bitrate higher than the low bitrate.

In accordance to an aspect, the audio signal representation encoding unit may be configured to select between the low order operation mode and the high order operation mode based on measurements related to the quality of the network connection (e.g. latency-related measurements and/or error-rate measurements, and/or connection bandwidth measurements, etc.), so that:
in case the measurements related to the quality of the network connection are indicative of low quality (e.g. high latency and/or high error rate, and/or low connection bandwidth, etc.), the audio signal representation encoding unit selects the low order operation mode, and,
in case the measurements related to the quality of the network connection are indicative of high quality, the high quality being higher than the low quality (e.g. low latency and/or low error rate, and/or connection bandwidth etc.), the audio signal representation encoding unit selects the high order operation mode.

(In order to carry out the selection, the measurements related to the quality of the network connection may be evaluated in respect to a predetermined quality threshold, so as to classify the quality of the network connection. For example, in order to determine whether the quality is high or low, the measurements related to the quality of the network connection may be evaluated with respect to at least one quality threshold, so as to distinguish between high quality and low quality. For example, the latencies may be evaluated with respect of a latency threshold, so as to classify the quality as low in case the latencies, e.g. the average latencies, are above the latency threshold, and to classify the quality as high in case the latencies, e.g. the average latencies, are below the latency threshold. Or, the error rate may be evaluated with respect of an error-rate threshold, so as to classify the quality as low in case the error rate, e.g. the average error rate, is over the error-rate threshold, and to classify the quality as high in case the error rate, e.g. the average error rate, is below the error-rate threshold. Or, the connection bandwidth may be evaluated with respect of a connection-bandwidth threshold, so as to classify the quality as low in case the connection bandwidth, e.g. the average connection bandwidth, is below the connection-bandwidth threshold, and to classify the quality as high in case the connection bandwidth, e.g. the average connection bandwidth, is above the error-rate threshold.)

In accordance to an aspect, the audio signal representation encoding unit may be configured to select between the low order operation mode and the high order operation mode based on battery-supply-related measurements, so that:
in case the battery-supply-related measurements are indicative of low battery supply of a battery supplying the audio signal representation encoding unit, the audio signal representation encoding unit selects the low order operation mode, and,
in case the battery-supply-related measurements are indicative of high battery supply, higher than the low battery supply, the audio signal representation encoding unit selects the high order operation mode.

(In order to carry out the selection, the battery supply may be evaluated in respect to a predetermined battery-supply threshold (charge threshold), so as to classify the battery supply and to perform the selection based on the classification. For example, in order to determine whether the battery supply is high or low, the battery-supply measurements may be evaluated in respect to at least one battery-supply threshold (charge threshold), so as to distinguish between high battery supply and low battery supply.)

In accordance to an aspect, the audio signal representation encoding unit may be configured to select between the low order operation mode and the high order operation mode based on a feedback signal from a receiver (e.g. decoding unit), so to select the operating mode requested in the feedback signal.

In accordance to an aspect, there is provided an audio encoder comprising:
the audio signal representation encoding unit of a previous aspect;
a quantizer and bitstream writer for writing, in a bitstream, the low order spatial audio signal representation.

According to an aspect, there is provided a method for decompressing an ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the method including using a plurality of sector decoding paths, each sector decoding path decoding a directional sector signal of the ambisonic spatial audio signal representation in each spatial sector by applying, to the at least one transport channel, or a sector signal derived from the transport channel, the directional parameter(s) and the sector diffuseness parameter(s) of the spatial sector,
the method including using a global diffuseness signal decoding path to derive a global diffuseness signal by applying, to the at least one transport channel, a global diffuseness parameter, or other information on the global diffuseness of the audio signal,
the method including combining, through a global diffuseness signal inserter, the plurality of decoded directional sector signals and the global diffuseness signal, to output the decompressed ambisonic spatial audio signal representation.

According to an aspect, there is provided a method for encoding an input spatial audio signal representation, representing an audio signal, onto a compressed ambisonic spatial audio signal representation representing the audio signal,
the method including deriving at least one transport channel and side information, the side information including sound field parameters, the sound field parameters including, for each spatial sector of a plurality of spatial sectors, directional parameter(s) providing information on a direction of arrival, DoA, in the specific spatial sector, the sound field parameters including sector diffuseness parameter(s) providing information on diffuseness of the audio signal in at least one spatial sector,
the method including using a plurality of sector parameter estimators, each sector parameter estimator processing a specific sector signal of the input spatial audio signal representation in a specific spatial sector of the plurality of spatial sectors, so as to derive the directional parameter(s) and the information on diffuseness of the audio signal in the at least one spatial sector,
the method including using an encoding of the at least one transport channel and the side information into a bitstream.

In accordance to an aspect, there is provided a non-transitory storage unit storing instructions which, when executed by a processor, cause the processor to perform the method of the previous aspects.

In accordance to an aspect, there is provided a compressed ambisonic audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector, and a global diffuseness parameter.

In accordance to an aspect, there is provided a compressed ambisonic audio signal representation, e.g. generated according to the method for encoding an input spatial audio signal representation described above

### BRIEF DESCRIPTION OF THE DRAWINGS

Embodiments of the present invention will be detailed subsequently referring to the ap-pended drawings, in which:

FIG. 1 shows examples of first order basis functions of an ambisonic representation.

FIG. 2 shows an embodiment of the prior art.

FIG. 3 shows an example of how to divide the sphere into two sectors.

FIG. 4 shows the basis functions of FIG. 1 after filtering with one of the sectors in FIG. 3

FIGS. 5a-5c show examples of audio signal representation decoding units according to the present disclosure.

FIG. 6 shows results of a subjective listening test comparing the invention to prior art.

FIG. 7 shows an example of an audio signal representation encoding unit according to the present disclosure.

FIG. 8 shows an example of an apparatus including an audio signal representation decoding unit of and of FIGS. 5a-5c.

FIGS. 9a and 9b show examples of present techniques.

FIGS. 9c and 9d show results obtained with the present techniques.

FIG. 10 shows an example of an audio signal representation encoding unit according to the present disclosure.

### DETAILED DESCRIPTION OF THE INVENTION

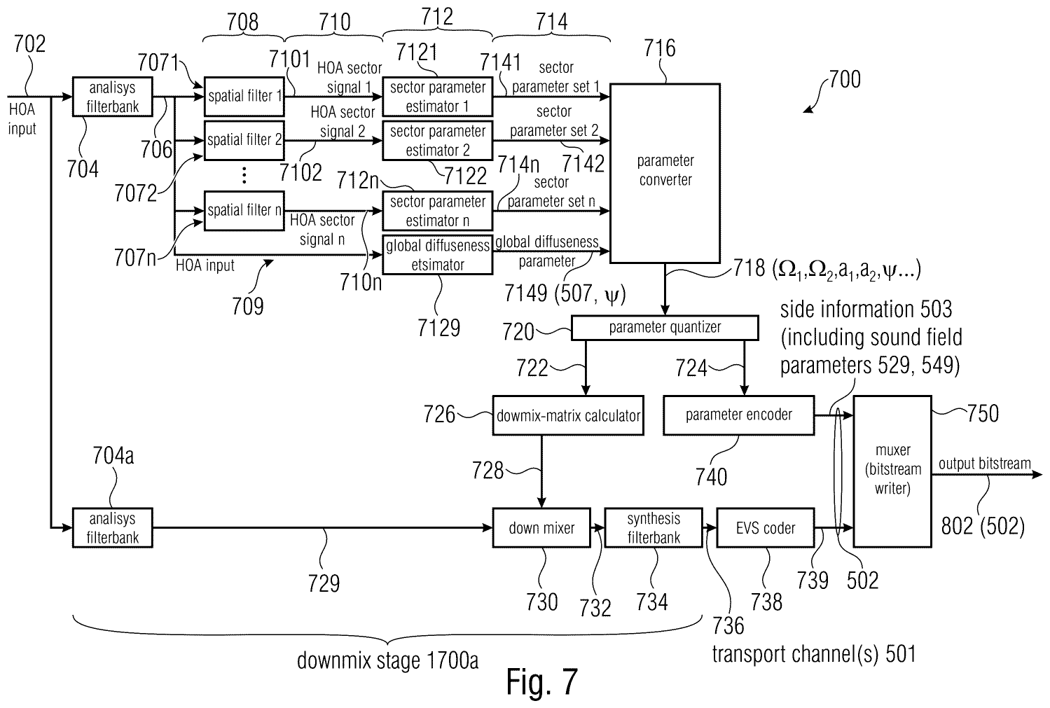

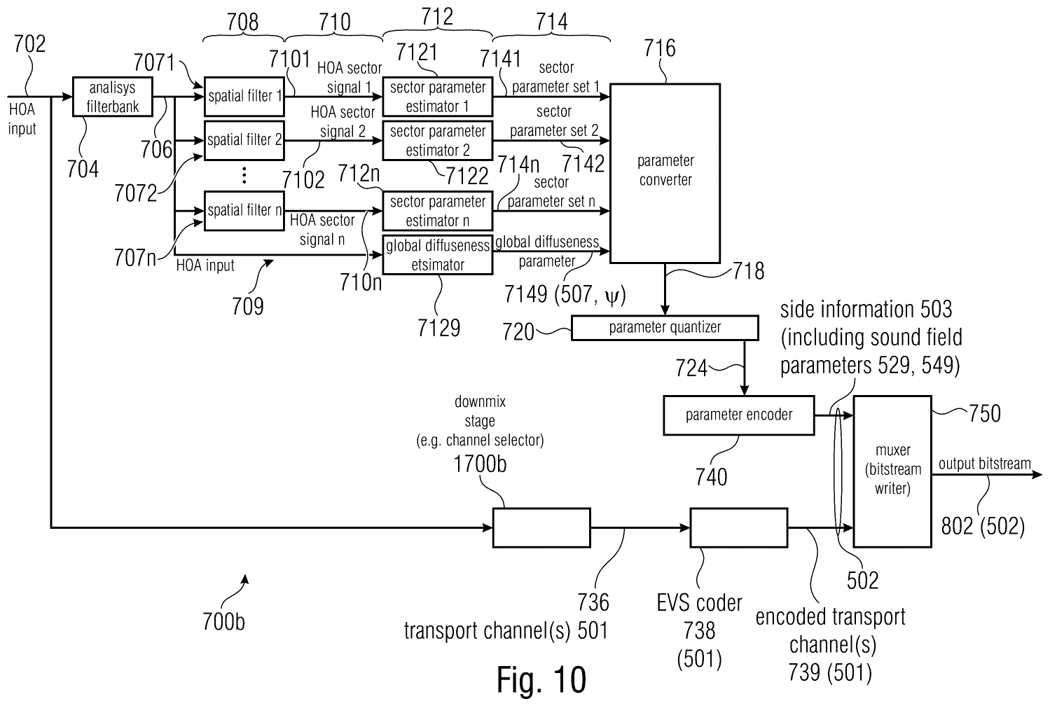

At first, reference is made to FIGS. 7 and 10. Each of them shows an audio signal representation encoding unit (700, 700b) (also called “encoder”) for encoding an input spatial audio signal representation (702), representing an audio signal (e.g. in higher order ambisonics), onto a compressed ambisonic spatial audio signal representation (502, 802) representing the audio signal (702). The audio signal representation encoding unit 700, 700b may be configured to downmix (e.g. at the downmix stage 1700a or 1700b) the input spatial audio signal representation (702) to derive at least one transport channel (736). The audio signal representation encoding unit may be configured to derive side information (503). The side information (503) may include sound field parameters (e.g. 714, 718, 549, 529). The sound field parameters (e.g. 714, 718, 549, 529) may include, for each spatial sector of a plurality of spatial sectors, directional parameter(s) providing information on a direction of arrival, DoA, in the spatial sector. The sound field parameters may include sector diffuseness parameter(s) providing information on diffuseness of the audio signal (702) in at least one spatial sector (e.g., the diffuseness parameters may be written in the audio signal representation 502, 802 for at least one spatial sector, but they may provide information on the diffuseness for the totality of the spatial sectors). The audio signal representation encoding unit (700, 700b) may include a plurality of sector parameter estimators (712, 7211, 7212, 721n). Each sector parameter estimator (712, 7211, 7212, 721n) may be configured to process a specific sector signal (710, 7101, 7102, 710n) of the input spatial audio signal representation (702) in a specific spatial sector of the plurality of spatial sectors, so as to derive the directional parameter(s) and the information on diffuseness of the audio signal (702) in the at least one spatial sector. The audio signal representation encoding unit may include a bitstream writer (750) to encode the at least one transport channel (736, 501) and the side information (503), which may be understood to embody the compressed ambisonic spatial audio signal representation (502, 802).

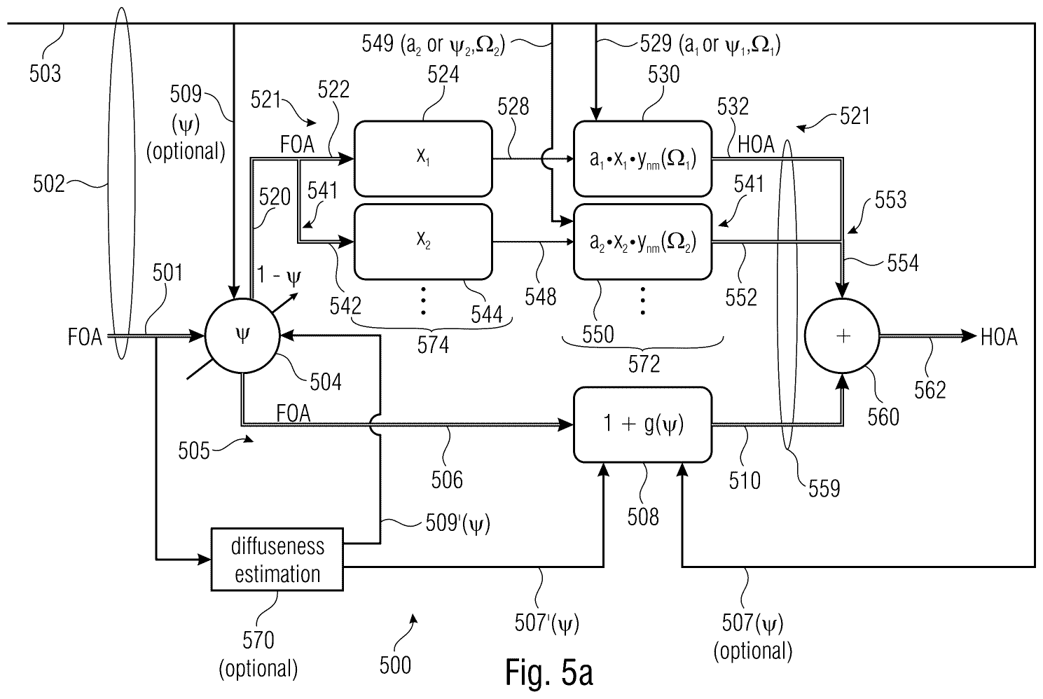

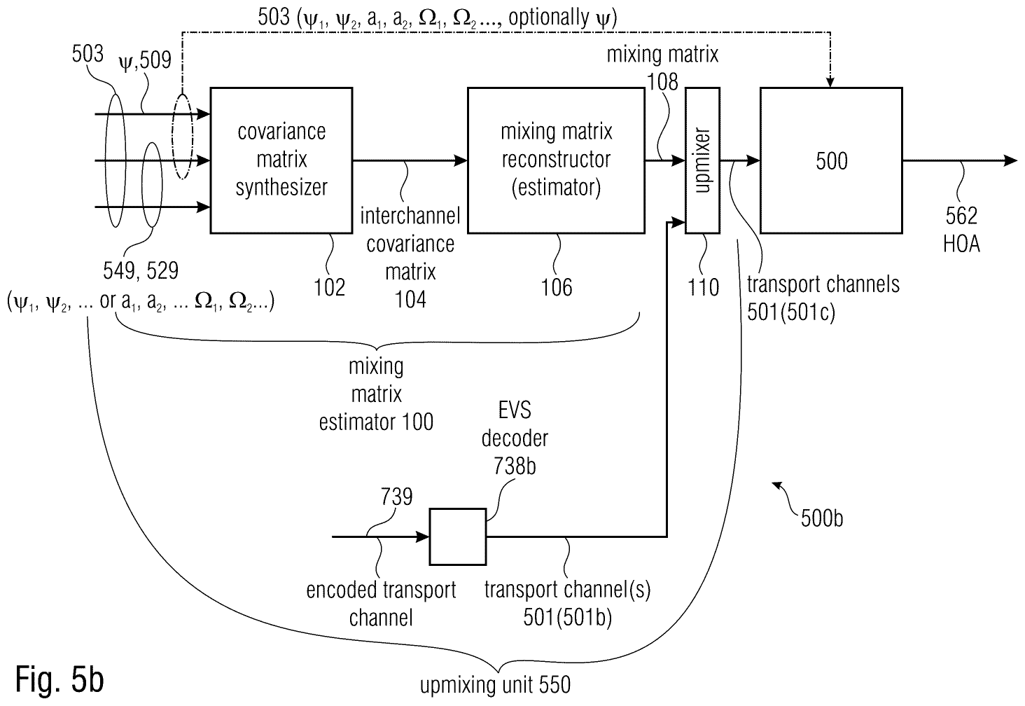

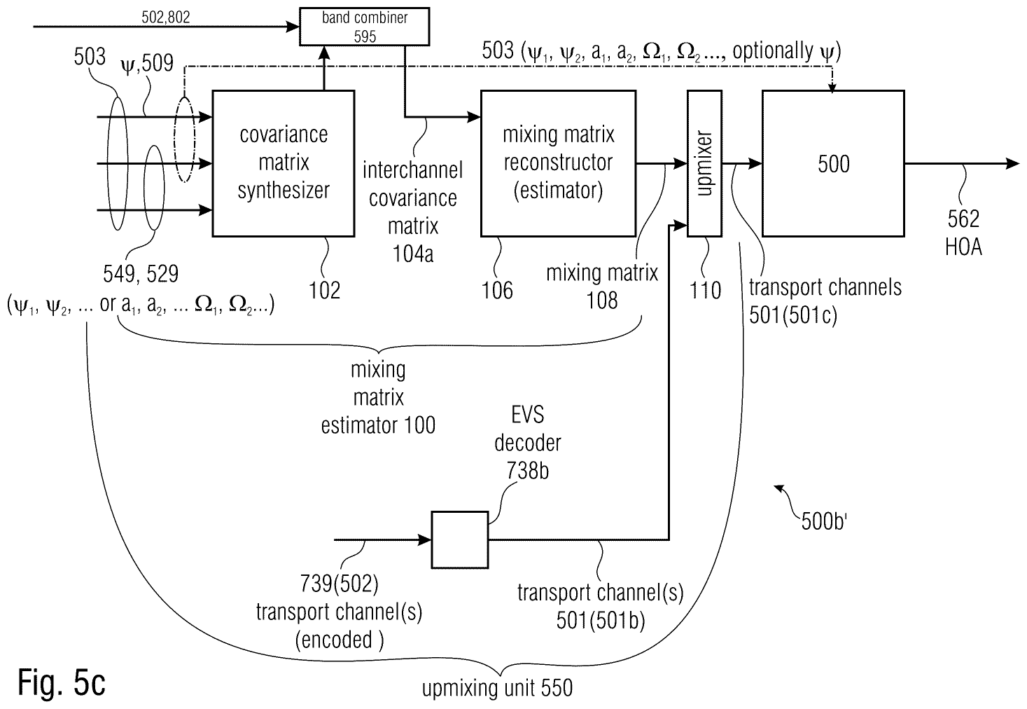

FIGS. 5a-5c show examples of audio signal representation decoding units (500, 500b, 500c) (also called “decoders”) for generating a decompressed ambisonic spatial audio signal representation (562) from a compressed ambisonic spatial audio signal representation (502) representing an audio signal, the compressed ambisonic spatial audio signal representation (502, 802) which may be, for example, the compressed ambisonic spatial audio signal representation (502, 802) generated by the audio signal representation encoding unit (700, 700b). As explained above, the ambisonic spatial audio signal representation (502, 802) may include at least one transport channel (501) and side information (503). The side information (503) may include sound field parameters (e.g. 529, 549, 718). The sound field parameters may include, for each spatial sector of the plurality of spatial sectors, directional parameter(s) (e.g. 529, 549, 718) providing information on a direction of arrival, DoA, in the spatial sector. The sound field parameters may include, for at least one spatial sector, sector diffuseness parameter(s) (529, 549) providing information on sector diffuseness of the audio signal in the at least one spatial sector (as explain above, the diffuseness parameters may be in the audio signal representation 502, 802 for at least one spatial sector, but they may provide information on the diffuseness for the totality of the spatial sectors). The audio signal representation decoding unit may include a plurality of sector decoding paths (521, 541). Each sector decoding path (521, 541) may be configured to decode a directional sector signal (532, 552) of the decompressed ambisonic spatial audio signal representation (562) in each spatial sector by applying, to the at least one transport channel (501), or a sector signal (528, 548), derived from the at least one transport channel, the directional parameter(s) (529, 549) and the sector diffuseness parameter(s) (529, 549) of the spatial sector. The audio signal representation decoding unit may include a global diffuseness signal decoding path (505) to derive a global diffuseness signal (510) by applying, to the at least one transport channel (501), a global diffuseness parameter (507, 507′, Ψ), or other information on the global diffuseness of the audio signal. The audio signal representation decoding unit may include a global diffuseness signal inserter (560) to combine the plurality of decoded directional sector signals (532, 552) and the global diffuseness signal (510), to output the decompressed ambisonic spatial audio signal representation (562).

Here below, the units discussed above are exemplified in detail.

FIG. 5a shows the audio signal representation decoding unit 500. The audio signal representation decoder unit (audio signal representation decoding unit) 500 may receive, in input, a compressed ambisonic spatial audio signal representation (e.g. FOA signal) 502 and to provide, in output, decompressed ambisonic spatial audio signal representation 562 (e.g. HOA, or high order decompressed ambisonic spatial audio signal representation). (The FOA signal 502 may be substituted with a low order ambisonic signal, and the HOA signal 562 may be an ambisonic signal with higher order than the low order ambisonic signal 502).

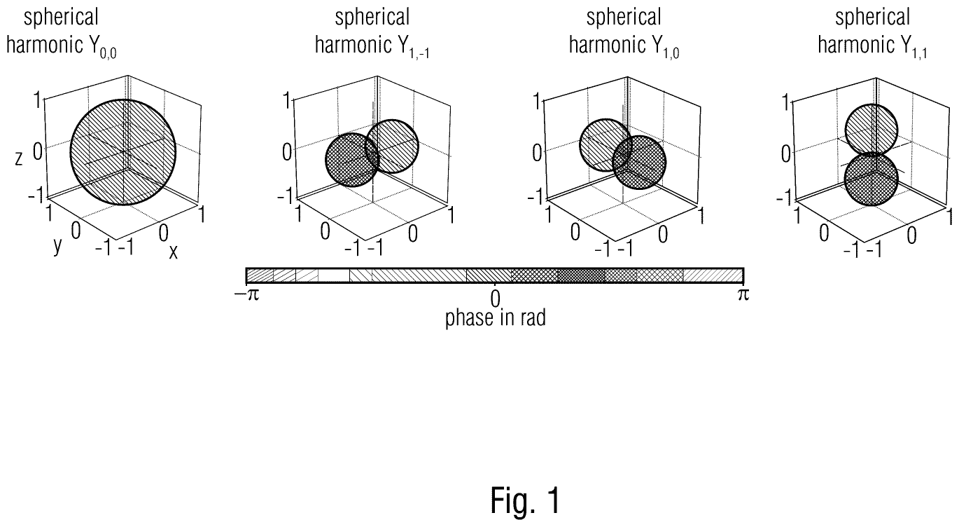

The compressed ambisonic spatial audio signal representation 502 may include at least one transport channel 501 (also represented in some cases, mathematically, as XL). The at least one transport channel 501 may include, for example, a downmixed version of an original audio signal representation (of an audio signal). In general terms, the at least one transport channel 501 may be understood as having downmixed channel(s) with respect to the original channels of the audio signal 702. Each channel may be an ambisonic component (ambisonic components are represented in FIG. 1). For example, there may be a plurality of channels, e.g. four channels, in the case of the compressed ambisonic spatial audio signal representation 502 being a FOA signal. Each transport channel 501 may be provided in, or converted from, a filterbank domain. Even though here below is often referred to at least one transport channel, this is notwithstanding valid also for a plurality of channels (e.g. four channels, or more). Notably, the transport channel(s) 501 may be processed, through the elements of FIG. 5a, to become the decompressed spatial audio signal representation 562.

In case the input compressed ambisonic spatial audio signal representation 502 is not in the filterbank domain, there may be a filterbank (not shown in FIG. 5a) which would convert the compressed ambisonic spatial audio signal representation into the filterbank domain, upstream to the elements shown in FIG. 5a. In some examples, downstream to the elements shown in FIG. 5a, there may be another filterbank synthesizer (also not shown in FIG. 5a), to provide the decompressed spatial audio signal representation 562 into a time domain, for example.

The at least one (or more) transport channel 501 (or the compressed ambisonic spatial audio signal representation 502) may be a FOA signal, or, more generally, a low-order ambisonic signal. One task of the audio signal representation decoder unit 500 (audio signal representation decoding unit) may be to obtain the decompressed ambisonic spatial audio signal representation 562 as the HOA, or at least a higher order ambisonic, signal corresponding to, and giving a possibly trustfully audio information of, the inputted HOA signal 702 in the encoder 700 or 700b.

The compressed ambisonic spatial audio signal representation 502 may include side information 503. The side information 503 may include sound field parameters. In examples, all time-frequency tiles within the same spatial sector may or may not share at least some of the sound field parameter. For example, some sound field parameters may be the same for all the bands. In some examples bands may be grouped together to save on the metadata. Also for some signals the parameters may be the same for some of all bands (in general they can be different for each band). In some cases, different bands may have different sound field parameters.

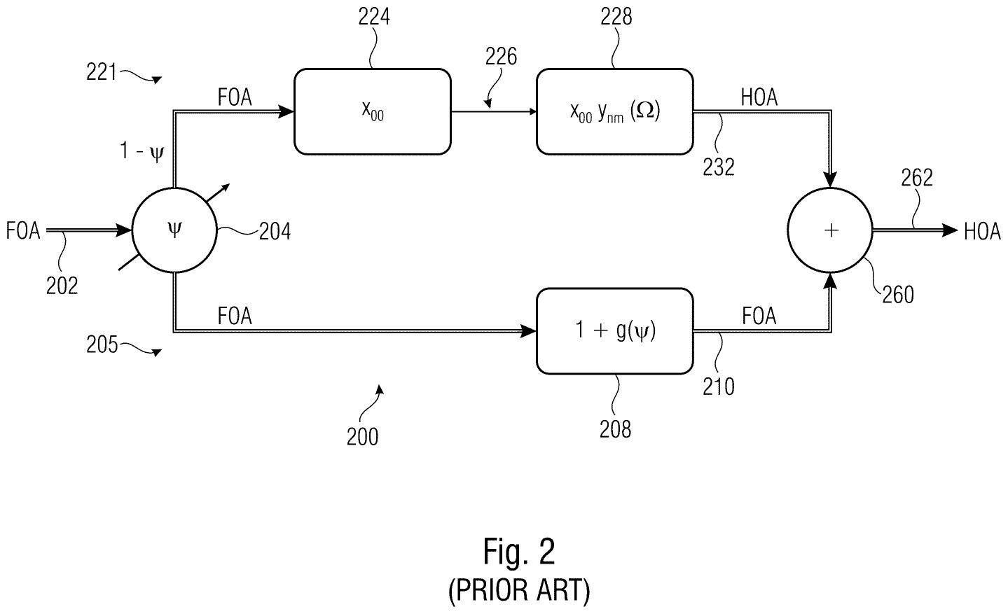

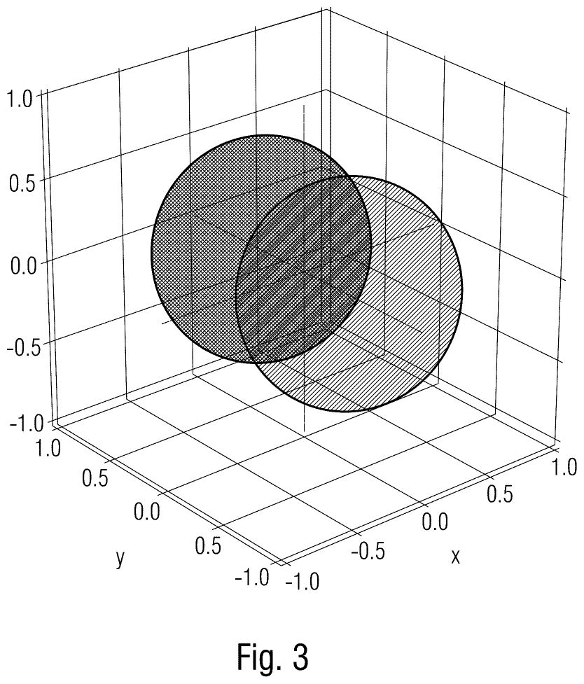

The sound field parameters 529, 549 may include, for specific spatial sectors of the plurality of spatial sectors, at least one directional parameter for each specific spatial sector. E.g., if there are two spatial sectors, there may be two directional parameters (one for each sector) for each frequency band. The sector index is denoted as s. The total number of sectors is N. Here it is often exemplified with N=2 (or sometimes, for generality, with N≥2). The space may be partitioned in spatial sectors. The position of the spatial sectors may be fixed (i.e. it may be known a priority by both the encoding unit 700, 700b and the decoding unit 500). The directional parameter may be, or otherwise provide information on, the direction of arrival, DoA, in the specific spatial sector. The DoA may be represented, for a specific spatial sector s, with the symbol Ωₛ, where s indicates the particular sector. For example, in the case of having two spatial sectors s=1 and s=2, we may have Ω₁ and Ω₂. In case of more than two spatial sectors, then there will be also Ω₃, Ω₄, etc. Therefore, at least one directional parameter 529, 549 may be provided. Therefore, for each spatial sector, a specific directional parameter may be defined (e.g. for each time-frequency tile). Contrary to the prior art as shown in the example in FIG. 2 (in which there is only one single DoA in the whole space), here there is one directional parameter for each spatial sector, and the spatial sectors are more than one.

The sound field parameters 529, 549 may also include at least one sector diffuseness parameter (529, 549 using the same reference numerals used for the directional parameter), which may provide information on the sector (local) diffuseness or, complementarily, on the sector (local) directionality. The sector diffuseness parameter will often be referred to with Ψₛ where s indicates the sector and, in case of two sectors, it may be referred to with Ψ₁ and Ψ₂ (or with 1−Ψ₁ and 1−Ψ₂ when it is here referred to the sector directionality). Another name for the “diffuseness” could be, for example, “diffuse energy ratio” Ψ=(diffuse energy)/(total energy) (where “/” means mathematic division). The global diffuseness (or global diffuseness energy ratio) may be Ψ=(diffuse energy in the space)/(total energy in the space), while the sector diffuseness (or sector diffuseness energy ratio) may be Ψₛ=(diffuse energy in the sector s)/(total energy in the sector s).

It is to be noted here that “directionality” is to be understood as a concept complementary to diffuseness (“global diffuseness” and “sector diffuseness”). Whether reference is made to Ψ₁ or Ψ₂ (in terms of diffuseness) or to 1−Ψ₁ and 1−Ψ₂ (in terms of “directionality”), information indicative of the “sector diffuseness” is notwithstanding present, since 1−Ψ₁ and 1−Ψ₂ are also indicative of Ψ₁ and Ψ₂, and vice versa (the same applies to the global diffuseness Ψ and the its complementary information 1−Ψ). Another name for “directionality” could be, for example, “directional energy ratio”, and the diffuseness which is the complementary of the diffuse energy ratio

(e.g., 1−Ψ=1−(diffuse energy)/(total energy)).

More in detail, it is here distinguished between “sector directionality” (1−Ψ₁, 1−Ψ₂) and “directional information” (e.g. provided in terms of Ω₁ and Ω₂): the “directional information” and the DoA provide geometrical information on the direction of the signal (e.g. intensity vector), without specifically indicating any weight information or energy information or intensity or pressure information or weight; while the “directionality” (1−Ψ₁, 1−Ψ₂) refers to concepts like a weight, intensity, energy, pressure, etc., which characterize the sound, without giving information on the DoA. In general terms, the more the audio signal is locally diffuse in the spatial sector, the less the audio signal is locally directional in the same spatial sector.

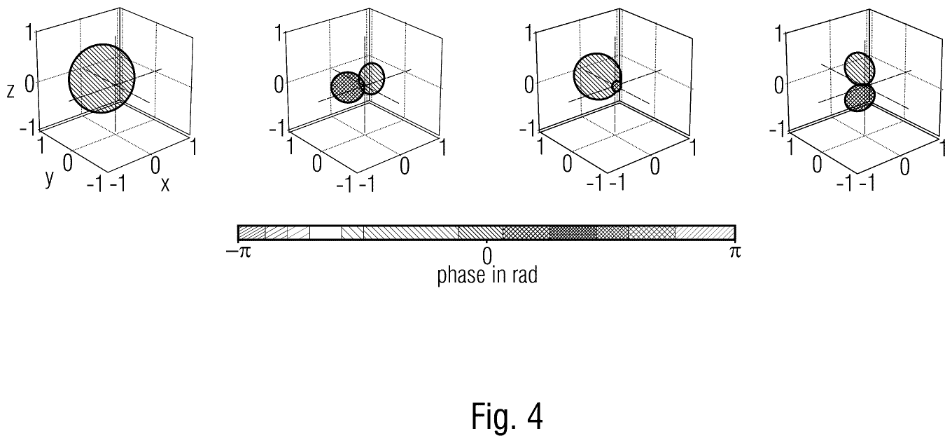

The side information 503 may also include, e.g. as sound field parameter, a global diffuseness parameter or other global diffuseness parameters (507, 507′, Ψ), or other information on the global diffuseness of the audio signal. The global diffuseness parameter is generally indicated by Ψ without indexes, and is a global characteristic, which describes the input signal. The global diffuseness parameter Ψ may therefore provide information for weighting the FOA transport channels 501 (e.g. at a splitter 504, see below) to derive a diffuseness component 506 in the path 505 (also show in FIGS. 1 and 4 as “diffuseness component”). Another way of providing the information on the global diffuseness of the audio signal could be to indicate 1−Ψ (or B−Ψ with B>0, e.g. fixed e.g. known a priori): even if 1−Ψ is the information complementary to the global diffuseness, it is still information on the global diffuseness.

As such, the global diffuseness parameters (507, 507′, Ψ), or other information on the global diffuseness of the audio signal, in some cases can also be estimated e.g., when the compressed ambisonic spatial audio signal representation 502 has four or more transport channels 501. In other situations, the global diffuseness parameters (507, 507′, Ψ), or other information on the global diffuseness of the audio signal, can be encoded in the side information 503

The at least one transport channel can be split among a globally diffuseness signal (weighted by Ψ, for example) and a non-globally diffuse signal (weighted by 1−Ψ, for example). Notwithstanding, the inventors have understood that the non-globally diffuse signal is not necessarily an “all directional signal” (i.e. it is not necessarily totally directional) and not necessarily uniquely distributed in one single DoA, but can also be distributed, among multiple sectors, between a local directional component (sector directional component) and a local diffuseness component (sector diffuseness component).

It will be shown that the inventors have also understood that it is not strictly necessary to calculate (or to have written in the sound field parameters), for each sector, both the sector directional component and the sector diffuseness component. In contrast, it is more easily possible to derive, for each sector, a relative directionality, measuring the directionality of each spatial sector over the total amount of the directionalities of all the spatial sectors. By weighting the at least one transport channel 501, for each spatial sector, through a mixing weight derived from the relative directionality of that spatial sector, it is simply possible to derive a sector directional signal which keeps into account, in itself, both its DoA and its sector diffuseness. (It will be shown that the relative directionality can be the ratio between the sector directionality in a spatial sector and the sum of the sector directionalities in the totality of the spatial sectors).

Here below reference is often made to sector diffuseness parameters. Relative directionalities can be examples of diffuseness parameters.

As can be seen in FIG. 5a, the at least one transport channel 501 may be subjected to a splitter 504, or another element in which weights conditioned by the global diffuseness parameters (507, 507′, Ψ), or other information on the global diffuseness of the audio signal, are applied. The splitter (or other element) 504 may split the compressed ambisonic spatial audio signal representation 502 into two signals so as to output a global diffuseness signal 506 (in compressed, FOA, version) and a remaining, globally-non-diffuse signal 520 (in compressed, FOA, version). The global diffuseness signal 506 may be understood as being weighted by a weight (e.g. Ψ) which increases at the increase of the diffuseness (e.g. a high diffuseness will cause a high Ψ, a total diffuseness will cause Ψ=1 or another maximum value, and a low diffuseness will cause a low Ψ, and no diffuseness at all will cause Ψ=0; at Ψ>0.5 the diffuseness signal 506 tendentially dominates over the globally-non-diffuse signal, while at Ψ<0.5 the remaining, globally-non-diffuse signal 520 is tendentially dominant over the diffuseness signal 506). The globally-non-diffuse signal 520 may be understood as being obtained from the transport channels 501 weighted by a weight (e.g. 1−Ψ) which increases at the reduction of the global diffuseness (i.e. increases at the increase of the global directionality). The globally-non-diffuse signal 520 may have the remaining energy. It may be, however, that the energy of the globally-non-diffuse signal 520 is in turn locally diffuse within one single sector. Also the globally-non-diffuse signal 520 will therefore be filtered into multiple sector signals (528, 548), and each sector signal (528, 548) will in turn be continued to arbitrary higher ambisonics orders using the spherical harmonics of these orders into a directional sector signal (532, 552).

In the global diffuseness signal decoding path 505, at block 508 (energy compensator), a gain 1+g (Ψ) can be provided, to weight the global diffuseness signal (component) 506 such that its energy matches the energy of a physically correct HOA signal (see WO 2020/115311 A1). In some cases, the gain 1+g(Ψ) may be

$$1 + g ( Ψ ) = \sqrt{1 + Ψ * ( \frac{H + 1}{L + 1} - 1 )}$$

where Ψ is, or is obtained from, the global diffuseness parameter (507, 509), or the other information on the global diffuseness of the audio signal; L is an ambisonic input order and H an ambisonic output order. (Other formulas are possible).

Alternatively, the gain may be chosen as

$$1 + g ( Ψ ) = \sqrt{1 + Ψ * ( {f}_{comp} - 1 )} ,$$

where the diffuse compensation factor may be

$${f}_{comp} = \frac{( \sum \begin{matrix}H \\ l = 0\end{matrix} \sum \begin{matrix}l \\ m = - l\end{matrix} \frac{1}{2 * l + 1} )}{( \sum \begin{matrix}L \\ l = 0\end{matrix} \sum \begin{matrix}l \\ m = - l\end{matrix} \frac{1}{2 * l + 1} )}$$

where l is the degree of a spherical harmonic and L is the ambisonic order of the input signal, or a signal comprising the transport channels and, optionally, channels generated via the use of decorrelators, and m is the index of a spherical harmonic and assumes values from −l to l, and H is a higher ambisonic order.

The value range of the global diffuseness gain may be limited to a certain value range as to prevent too strong deviations from the global diffuseness signal (506).

The energy compensator unit 508 may apply the gain to the global diffuseness signal 506 to adjust the energy distribution as to obtain a more physically realistic ambisonics output signal.

It is noted that it is in general considered to be 0≤Ψ≤1 (where Ψ=0 when the signal is completely directional and Ψ=1 when the signal is completely diffused; in some examples, 1 may be substituted by a value B>0). Through the gain, the FOA global diffuseness signal (component) 506 is amplified through the gain 1+g(Ψ). Notably, a higher diffuseness (e.g. Ψ close to 1) implies a gain which is higher than in case of lower diffuseness (e.g. Ψ close to 0).

FIG. 5a shows that the global diffuseness parameters (507, 507′, Ψ), or other information on the global diffuseness of the audio signal may be either obtained, as parameter 507, from the side information 503 or, alternatively, may be estimated at an optional diffuseness estimator 570 estimated as 507′ and/or 509′ (e.g. when the signal is ambisonics or multichannel), e.g. using a pseudo intensity vector or covariance-related techniques (507′ and 509′ may be the same). The diffuseness 507′ (509′) may be obtained, by the optional diffuseness estimator 570 from the intensity vector and the average energy (this is the way comply used for DirAC).

The output of energy compensator block 508, here indicated with 510, is the global diffuseness signal 510 of the HOA signal, where the diffuse component of the HOA output signal. Typically it contributes only to the first-order channels of the higher-order output signals.

In parallel to the processing at the global diffuseness path 505, the globally-non-diffuse signal 520 (e.g., resulting as output 520 from the splitter 520, e.g. after the FOA signal 501 being scaled by (1-Ψ) may be processed at the plurality of sector decoding paths 521, 541. For simplicity, FIG. 5a shows only two sector decoding paths 521 and 541. In general, there may, however, be an arbitrary number of sector decoding paths. In some implementations, N=2 sector decoding paths may be a reasonable design choice, which represents a good trade-off between the necessity of having good results and the necessity of keeping low the computational effort.

The globally-non-diffuse signal 520 may be subjected, at spatial filtering stage 574, to a spatial filtering. The inputs of the spatial filtering stage 574 are indicated with 522 and 542 (which may be signals equal to each other, and also equal to the globally-non-diffuse signal 520), each of the inputs 522 and 542 entering in a respective spatial filtering block 524, 544. The spatial filtering blocks 524, 544 are part of the spatial filtering stage 574, and each spatial filtering block filters the globally-non-diffuse signal 520, to limit the globally-non-diffuse signal 520, in each sector decoding path, to a particular spatial sector. Therefore, at the output of spatial filtering block 524 in path 521, the transport channel(s) (in their sector-limited version 528) is limited to the sector s=1, while at the output of spatial filtering block 526 in sector decoding path 522, the transport channel(s) (in their sector-limited version 548) is limited to the sector s=2. In order to obtain spatial filtering, the spatial filtering stage 574 may perform a beamforming. Downstream to the spatial filtering stage 574, the sector signal 528 of the spatial sector s=1 is different from the sector signal 548 of the spatial sector s=2, since they are limited to different spatial sectors.

Notably, the spatially filtered signal 528, 548 of each sector decoding path 521, 541 can be understood as still being subjected to another subdivision between a sector diffuse component and a DoA component: the sector signal simply lacks of the global diffuseness component (signal 510) which has already been polished at the splitter 504 (the global diffuseness component can be seen as acting as a common mode, which has been removed at splitter 504). Therefore, each spatially filtered signal 528, 548 outputted by a relative block 526, 546 may be considered a sector signal, which provides signal information for the particular spatial sector.

The spatial filtering stage 574 may be instantiated by a plurality of spatial filters at blocks 524, 544 and so on. At each of blocks 524, 544, and so on, for each spatial sector, a beamforming may be performed. In some examples, these may be obtained by x_{S}=wₛ^{T}*x_{L} where w contains the beamforming weights vector for spatial sector s and x_{L} is the signal 528, 548 outputted by the block 574 and “T” stands for the transpose operator. The beamforming weights vector may be known a priory by the decoder. Notably, w^{T}ₛ may be an operator in abstract representation having multiple elements, each of them being a weight w_{nm,s}^{T} (e.g. wₛ^{T}=[w_{0,0}, w_{1-1,s}, w_{10,s}, w_{11,s}, . . . ]).

At subsequent sector signal processor stage 572 (including sector signal processor blocks 528, 548) the sector signals 528, 548 (processed transport channels, spatially filtered signals, etc.) are each continued (extended) to a higher Ambisonics order using a vector of spherical harmonics evaluated along the spatial sector DoA Ωₛ (i.e. the local DoA internal to a specific spatial sector, e.g. as indicated in the sound field parameters 529, 549 of the side information 503). This may, for example, be achieved by (or in any case verify) the formula

$${x}_{s} = Y ( {Ω}_{s} ) * {x}_{s} = [ {x}_{s} * {Y}_{00} , {x}_{s} * {Y}_{1 - 1} , {x}_{s} * {Y}_{10} , {x}_{s} Y , … ] ,$$

with the scalar value xₛ being one of the sector signals 528, 548 (e.g. remembering that xₛ=w^{T}ₛ*x_{L}), and s indicating the particular spatial sector. A scaling by 1−Ψ (applied at the splitter 504) is not shown here explicitly as it enters into the formula via the sector signals xₛ−Ψ(Ωₛ) is a vector of the spherical harmonic functions (e.g. calculated or read from tables by the decoder) which permits to reconstruct the higher-order directional sector signal 532, 555 along the respective spatial sector DoA Ωₛ. xₛ is the vector of the decoded directional component of the spatial sector s in HOA.

The components of the vector are the real spherical harmonics Y_{i,m}(Ω) in ambisonics-channel-numbering (ACN) order (where Ω may be in terms of (φ, θ), for example). These are defined as (see [WO 2020/115311 A1])

$${Y}_{l , m} ( φ , θ ) = \{ \begin{matrix}{N}_{l , m} * {P}_{l}^{m} * sin θ * sin ( \vert m \vert * φ ) if m < 0 \\ {N}_{l , m} * {P}_{l}^{m} * sin θ * cos ( \vert m \vert * φ ) if m \geq 0\end{matrix}$$

(where “| . . . |” indicates the absolute value, i.e. |−1|=+1, |0|=0, and |+1|=+1) with the associated Legendre polynomials Pₗ^{m} and a normalization term for both the Legendre functions and the trigonometric functions which takes the following form for SN3D ([WO 2020/115311 A1], [Zotter and Frank]):

$${N}_{l , m} = \sqrt{\frac{2 - {δ}_{0 , m}}{4 π} * \frac{( l - \vert m \vert ) !}{( l + \vert m \vert ) !}}$$

For the ambisonic order L, the indices l and m run over l=0, . . . , L and m=−l, . . . , l, respectively, where δₘ is 1 for m=0 and 0 otherwise, and “!” indicates the factorial.

The spatially filtered signal 528, 548 may therefore be subjected to the sector signal processor stage 572 which may include the plurality of blocks 530, 550 for the paths 522, 542, to obtain directional sector signals 532, 552 (in higher order ambisonic format), respectively. For example, a sector signal processor block 530 may be applied to the filtered signal 528 as outputted by the block 524, while the sector signal processor block 550 may be applied to the signal 548 as outputted by the block 544 for the path 541. This may be repeated, for example, for each spatial sector s. It will be shown that by operating accordingly, each block 530, 550 and so on of the sector signal processor stage 572 may make use of a sector diffuseness parameter (e.g. Ψ₁ and Ψ₂, or a₁, a₂, as discussed below) and/or DoA for the spatial sector s, such as, Ωₛ instantiated in Ω₁ and Ω₂ for path 521, 541, respectively. In practice, it is retrieved, for each spatially filtered signal 528, 548 of each path 521, 541, a directional signal 532, 552 of the spatially filtered signal 528, 548. Since, as explained above, the “spatially filtered signal 528, 548 of each path 521, 541” is the “sector signal” of a particular sector, it is possible to imagine the signal 528, 548 as a directional component (local component) of the audio signal in the particular spatial sector.

For example, in case of two spatial sectors (s=2), it is possible to make use of coefficients (mixing weights) a₁ and a₂, each of them expressed as a ratio indicating, for example, the sector directionality 1−Ψ₁ (respectively 1−Ψ₂) over the sum of the sector directionalities of all the sectors 1−Ω₁+1−Ψ₂ (respectively, the same 1−Ψ₁+1−Ψ₂). An example can be:

$${a}_{1} = \frac{1 - {Ψ}_{1}}{1 - {Ψ}_{1} + 1 - {Ψ}_{2}} and {a}_{2} = \frac{1 - {Ψ}_{2}}{1 - {Ψ}_{1} + 1 - {Ψ}_{2}}$$

which in this case (since s=2) is

$${a}_{2} = 1 - {a}_{1} .$$

a₁ and a₂ are therefore complementary to 1 (or another B>0 in other examples). At least one of the parameters

$${a}_{1} = \frac{1 - {Ψ}_{1}}{1 - {Ψ}_{1} + 1 - {Ψ}_{2}}$$

$${a}_{2} = 1 - {a}_{1}$$

may be obtained by processing the sector diffuseness information 529, 549 e.g. as received from the side information 503. In other examples, a₁ and/or a₂ may be directly retrieved from the side information 503. Notably, in case of s=2 sectors, it is possible to encode only a₁ (respectively a₂), so that the audio signal representation decoding unit 500 retrieves a₂ (respectively a₁) by subtraction from 1 (or B). Therefore, in some cases there may be the provision, form the side information, of less sector diffuseness parameters, despite the fact that they notwithstanding provide a description of the sector diffuseness (and sector directionality) for all the spatial sectors. For example, given that the sum of the N relative directionalities aⱼ is 1 (or another B>0), it is possible that there are encoded simply n−1 relative directionalities, so as to obtain the N-th relative directionality as 1−(a₁+a₂+ . . . +a_{N-1}).

The coefficients a₁, a₂, (generally indicated also as as) may be applied to the spherical harmonic evaluated along the DoA sector DoA Ωₛ (i.e. the local DoA internal to a specific spatial sector). We may see that the directional sector signal 532, 552 may be

$${x}_{H , n m , s} = ( 1 - Ψ ) * {a}_{s} * {Y}_{n m} ( {Ω}_{s} ) * {x}_{s} .$$

In this expression, 1−Ψ is applied at the splitter 504, xₛ at the spatial filtering stage 574, and aₛ*Yₙₘ (Ωₛ) at stage sector signal processor 572. Different processing may be performed, however.

It is notwithstanding important to notice that the directional sector signal 532, 552 may be seen as having the following terms (at least in some examples):
the spherical harmonic Yₙₘ(Ωₛ) evaluated along the spatial sector DoA Ωₛ (or another information which permits to apply the DoA to the transport channel);
the global directionality 1−Ψ (or another global diffuseness information which permits to polish the global diffuseness component from the transport channel);
the coefficient aₛ (or another sector diffuseness parameter). In the specific case, aₛ can be seen as the relative sector directionality of the current sector s over the totality of sectors n.

Basically, in the sector decoding paths 522, 542, etc., the directional sector signals 532, 552 may be weighted according to their relative sector directionality aₛ, after that all of them (520, 522, 542) have been weighted by the global directionality 1−Ψ. In this way, they also keep into account the sector diffuseness of each of them.

Other kinds of coefficients, also different from a₁ and a₂ may be used. For example, the diffuseness parameters may directly indicate Ψ₁ or 1−Ψ₁ or and Ψ₂ or 1−Ψ₂ for example.

In case of more than two sectors, aₛ (with s>2) may be used (in some cases, the condition Σₛaₛ=1 or Σₛaₛ=B>0 may be given).

The coefficients a and a₂ may be applied to the spatially filtered signals 528, 548 and so on. An example of applying the coefficients may be, for example, x_{H,nm,s}=aₛ*xₛ*Y(Ωₛ) for each sector, thereby obtaining the directional sector signals 532, 552 and so on.

Thanks to the application of the coefficients as (applied to different spatial sectors s=1, 2 . . . ), it is possible to provide different diffuseness for different sectors.

The coefficient a₁, for example, is high where the directionality of the signal 522 in a first spatial sector s=1 is high with respect to a second spatial sector s=2. Therefore, if the signal in sector s=1 (path 521) is very directional and the signal in sector s=2 is locally very diffuse, then there will be tendentially a₁>a₂, while if the signal in sector s=1 (path 521) is very diffuse and the signal in sector s=2 is very directional, then there will be tendentially a₁<a₂.

The coefficient as may therefore be considered to provide a diffuseness information (and therefore be a sector diffuseness parameter), because it gives information on the sector diffuseness (in the specific spatial sector). However, the as is a sector directionality of sector s over the sum of the sector directionalities of all the spatial sectors (i.e. a relative directionality). The more directional sectors will have a higher as (e.g. close to 1, in particular if the other sectors are extremely diffuse), and the more locally diffuse sectors will have a lower as (e.g. close to 0, in particular if the other sectors are extremely directional).

It can be understood that the coefficient as will weight the intensity of the audio signal 528, 548 along the DoA Ωₛ (at least, in respect to the other directions of the same spatial sector), and the weight will be tendentially high if the signal is highly directional in the spatial sector s (and tendentially low if the signal is highly locally diffuse in the spatial sector s), and the weight will be tendentially higher than another sector s₂ if the signal is more directional in the spatial sector s than in the other sector s₂ (and tendentially lower than another sector s₂ if the signal is more diffuse in the spatial sector s than in the other sector s₂). (It is to be noted that the conversion of the transport channel may be obtained from the relationship x_{nm,s}=Y(Ωₛ)*xₛ=[xₛ*Y₀₀, xₛ*Y₁₋₁, xₛ*Y₁₀, xₛ*Y₁₁, . . . ].)

In general terms, the coefficient as may be an example of a mixing weight derived from the sector diffuseness parameter (it can be, for example, the sector diffuseness parameter itself). The higher the as, the higher the mixing weight applied to the particular path.

Basically, it is possible to overcome the problems and the issues in the prior art which goes beyond the impairments of the standard ambisonic model. Therefore, multiple directional sources in the same time-frequency tile and the specular reflections be taken into account.

It is to be noted that the directional signals 522, 542 (are, when in their version 532, 552, HOA signals. The vector of the spherical harmonic functions Y (Ω) can be trivially evaluated at arbitrary Ambisonics orders. Hence, it allows to reconstruct the signal at the originally recorded order or to artificially extend it to higher order to create a better listening experience.

The audio signal representation decoding unit 500 may include a global diffuseness signal inserter 560. The global diffuseness signal inserter 560 may combine the plurality of decoded sector signals (532, 552, x_{H,nm,s}) with the global diffuseness signal 510, so as to insert the global diffuseness (510) to the sector signals 532, 552, etc. The output of the global diffuseness signal inserter 560 may, therefore, be the compressed ambisonic spatial audio signal representation 562.

The signal 559, here intended as a juxtaposition of this directional signals 532, 552 and so on, and the global diffuseness signal 510 outputted by energy compensator block 508 is therefore indicated with reference numeral 559.

Summarizing, the audio signal representation decoding unit 500 can generate a decompressed ambisonic spatial audio signal representation 562 from a compressed ambisonic spatial audio signal representation 502 representing an audio signal, using, as side information 503:
sound field information including, for each specific spatial sector:
   directional parameter(s) (e.g. 529, 549, Ωₛ) providing information on a direction of arrival, DoA, in the specific spatial sector;
   sector diffuseness parameter(s) (e.g. 529, 549, Ψ₁, Ψ₂, a₁, a₂, etc.) providing information on sector diffuseness of the audio signal in the specific spatial sector;
a global diffuseness parameter (507, 507′, 509′, Ψ), or other information on the global diffuseness of the audio signal (which may be part, or not, of the side information 503, and/or may be part, or not, of the sound field parameters; or which may be estimated e.g. by the global diffuseness estimator 570).

These parameters may be easily applied to the at least one transport channel 501 (in FOA version) of the audio signal representation 502, to obtain the decompressed, HOA version 562 of the audio signal. At different sector decoding paths (521, 541, etc.) spatially filtered versions (528, 548) of the transport channels 501 may be obtained, each spatially filtered version (528, 548) representing the audio signal within the particular spatial sector. After that each spatially filtered transport channel 528, 548 is continued to a HOA signal using spherical harmonics evaluated at the DoA for each sector, it is possible to apply a mixing weight, to each sector signal 528, 548 which (in some examples) weighting the sector signals 528, 548 according to the sector directionality of the audio signal in the particular sector (the mixing weight may be a relative directionality of each spatial sector versus the sum of the directionalities of all the spatial sectors).

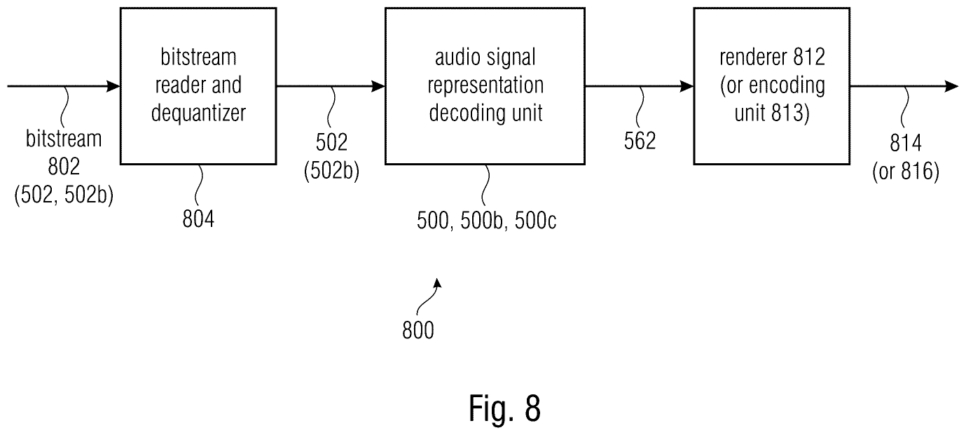

FIG. 8 shows an example of an apparatus 800 including the compressed ambisonic spatial audio signal representation 502, which renders an audio signal (as rendered audio signal 814) or transcoded the audio signal (as transcoded signal 816) from the compressed ambisonic spatial audio signal representation 502. Further, the compressed ambisonic spatial audio signal representation 502 may also be obtained from a bitstream 802 (coded signal). The apparatus 800 may have a bitstream reader (coded signal reader) and dequantizer 804, which may read the bitstream 802 (encoding the compressed ambisonic spatial audio signal representation 502 or 502b) and to provide the compressed ambisonic spatial audio signal representation 502 or 502b to the audio signal representation decoding unit 500 (or 500b). The decompressed ambisonic spatial audio signal representation 562 may be outputted by the audio signal representation decoding unit 500 or 500b, to a renderer 812, to render the audio signal 800 to an audio signal 814 (which should generally be the best reproduction as possible of the original audio signal 702) or an encoding unit 813, which may re-encode the audio signal ambisonic spatial audio signal representation 562 onto a different spatial audio signal representation 816. The different compressed ambisonic spatial audio signal representation 816 may also be stored and/or transmitted (sent) to other devices or units. In this way, if the renderer 812 is not used for obtaining the signal 814, by the encoding unit 813 is obtained to obtain a second spatial audio signal representation 816, then a transcoder is realized by the apparatus 800. In some examples, neither the renderer 812 nor the encoding unit 813 are present, and the output is simply the 562 decompressed ambisonic spatial audio signal representation 562.

FIG. 10 shows an audio signal representation encoding unit (e.g. encoder) 700b, which may be used, for example, for providing the bitstream (coded signal) 802 (in general terms, only metadata that are to be provided to the audio representation decoding unit 500 are the compressed ambisonic spatial audio signal representation 502, as well as the plurality of directional parameters and the parameter(s) indicating the sector diffuseness, which may vary in different spatial sectors). The audio signal representation encoding unit 700b may permit to provide the compressed ambisonic spatial audio signal representation 502, in case encapsulated in a bitstream (coded signal) 802.

The audio signal representation encoding unit 700b of FIG. 10 may be inputted with an audio signal (input audio signal representation, which represents an audio signal) 702, which may be, for example, an ambisonic signal in the time domain (the audio signal representation encoding unit 700b may include a converter into higher order ambisonics, HOA, time domain, e.g. from a non-ambisonic time domain version, which is not shown in the figure, but is upstream to the HOA signal 702 is FIG. 10). Further, the input audio signal representation 702 may be obtained from a version acquired from microphone(s), or may be synthesized. The input audio signal representation 702 may be therefore in general a non-compressed, HOA, representation of an audio signal. The audio signal representation encoding unit 700b may therefore compress the input audio signal representation 702 onto a FOA (or at least a lower order ambisonic), compressed version 502 (802) of the input audio signal representation 702, so as to represent the same audio signal in compressed version. It will be shown that the encoded audio signal representation 502 may include at least one transport channel 501 (in one of its versions 736 or 739) and side information 503, such as sound field parameters (e.g., as discussed above and below). In particular, the at least one transport channel 501 may represent a downmixed version of the HOA signal 702 (e.g., the at least one transport channel 501, e.g. in its version 736, may have a selected quantity of channels in respect to the HOA signal 702).

The high order ambisonic (HOA) audio signal representation encoding unit 700b may be provided to an analysis filterbank 704 to obtain a HOA signal version 706 of the input audio signal representation 702 in the filterbank domain, i.e. in time-frequency domain (so that the audio signal is subdivided into time-frequency tiles). The filterbank domain version 706 of the input audio signal representation 702 may be provided to a spatial filter stage 708. The spatial filtering stage 708 may perform a beamforming, e.g. by applying beamforming weights to the filterbank-domain HOA signal 706. The HOA signal 706 may correspond to the decompressed HOA signal 562 of FIG. 5a. The spatial filtering stage 708 may be instantiated by spatial filters 7071, 7072, . . . , 707n, one for each spatial sector (e.g., if there are two spatial sectors, then there will be two filters, i.e. N=2; in general, N>1). Each spatial filter 7071, 7072, . . . , 707n may cut the audio signal 706 into spatial sectors (e.g., the N=2 spatial sectors could be two hemispheres, or other subdivisions of the space could be defined). What is obtained at the spatial filtering stage 708 is a spatially filtered ambisonic uncompressed signal 710, formed by several sector directional signals 7101, 7102, . . . , 710n (one for each s spatial sector of the N>1 spatial sectors). The sector directional signals 7101, 7102, . . . , 710n may correspond to the sector directional signals 532, 552 of FIG. 5a, while the spatially filtered ambisonic signals 710 may correspond to the signals 528, 548 of FIG. 5a.

The spatially filtered version of the uncompressed, HOA signal 710 may be provided to a sector parameter estimator stage 712, which may include a plurality of sector parameter estimators 7211, 7212, 721n, each of them being configured to derive sound field parameters 7141, 7142, . . . , 714n respectively from the signals 7071, 7072, . . . , 707n. Basically, each value 7141, 7142, 714n may include a couple of parameters, such as both DoA directional information (e.g., Ω₁, Ω₂, . . . , Ω_{N}) for each particular spatial sector 1, 2, . . . , N, and a local (sector) diffuseness information (e.g., in terms of sector diffuseness Ψ₁, Ψ₂, . . . , Ψ_{N} and/or, complementarily, in terms of local directivity 1−Ψ₁, 1−Ψ₂, . . . , 1−Ψ_{N}) for each particular spatial sector 1, 2, . . . , N (in some cases, not all the sector diffuseness information is calculated; for example, of the all N spatial sectors, it is possible to actually calculate the diffuseness parameter for each of N−1 spatial sectors).

In parallel, a global diffuseness estimator 7129 (in global diffuseness path 709) may be provided, to provide the global diffuseness parameter (e.g., information on the global diffuseness), here indicated with 7149. The parameters 714 (7141, 7142, . . . , 714n), i.e. directional parameters and/or diffuseness parameters, can then be encoded in the bitstream (coded signal) 802 (502), either directly or in a processed version, as sound field parameters encoded in the side information 503. A parameter converter unit 716 (if present) may provide the directional parameters and diffuseness parameters 718 in processed form. If the parameter converter is provided, then the coefficients a₁, a₂ . . . etc. may be derived, e.g. using the formulas

$${a}_{1} = \frac{1 - {Ψ}_{1}}{1 - {Ψ}_{1} + 1 - {Ψ}_{2}} and / or {a}_{2} = \frac{1 - {Ψ}_{2}}{1 - {Ψ}_{1} + 1 - {Ψ}_{2}} = 1 - {a}_{1}$$

as above (as explained above, in case of N=2 spatial sectors the encoding of a₁ or a₂ may be skipped). The parameters 714 (7141, 7142, . . . , 714n, 7129) and/or 718 may therefore be or be processed to become the side information 503 (529, 549, 507).

The parameter converter unit 716 may therefore convert the sector diffuseness parameter(s) from a first representation 714 associating, with each specific sector component, information indicative of the sector diffuseness (Ψ₁, Ψ₂), to a second representation 718 associating, with the specific sector signal, information (a₁, a₂) indicative of a relative directionality of the sector signal in respect to the directionalities of the totality of sector signals. (The parameter converter unit 716 may be not necessary in some cases, e.g. where the sector diffuseness is directly written in the bitstream 802).

A parameter quantizer 720 may quantize the parameters 718. Quantized parameter 724 may be provided to a parameter encoder 740, which may encode the parameters 718 (e.g., in the quantized version 724) in the bitstream 802, as side information 503. Therefore, the side information 503 may be present in the sound field parameters 729, 549, such as at least some of Ψ₁, Ψ₂, 1−Ψ₁, 1−Ψ₂, Ω₁, Ω₂, a₁, a₂ . . . , and, in some cases, also the global diffuseness parameter Ψ or other information on the global diffuseness of the audio signal). In order to save on the metadata bitrate, the quantization of the Ωₛ may be automatically reduced to coarser steps for sectors where the diffuseness is high.

The input audio signal representation 702 may also be provided to an analysis filterbank unit 704a. A filtered version 729 of the input signal 702 in the filterbank domain (e.g. time-frequency tiles) may therefore be outputted by the analysis filterbank unit 704a. The version 729 of the input audio signal representation 702 may the same as the version 706 outputted by the analysis filterbank 704, but in other cases it may be different.

The encoder 700b (audio signal representation encoding unit) of FIG. 10 may also comprises a downmix stage 1700b to downmix the audio signal 702 into a compressed (downmixed) version 736. The downmix stage 1700b may be instantiated, for example, by a channel selector. By virtue of the input audio signal representation 702 (HOA signal) including a plurality of channels, the channel selector 1700b may simply select the channels corresponding to the FOA version (or at least a lower-order version) of the HOA signal 702 (the selected channels may be, for example, in a plurality of channels; e.g. they may be four channels, e.g. in the case of FOA, or more channels). This selection operation, trivial in nature, permits to compress the audio signal 702, which therefore will require less bits. However, most of the audio information will not be lost, since will be reconstructed by the audio signal representation decoding unit (e.g. 500) through the side information 503. For example, the (downmixed, compressed) transport channel(s) 736 may include four channels, e.g. less than the HOA signal 702. The transport channels 736, together with the side information 503, may constitute the compressed ambisonic spatial audio signal representation. Notably, FIG. 10 shows that a EVS (enhanced voice signal) coder 738 may be present, to convert the transport channels 736 into an encoded version 739 of the transport channels 736.

FIG. 7 shows another example of audio signal representation encoding unit 700. Here, components 704, 708, 704, 712, 716, and 720 (or at least some of them) may be basically the same of the example 700b of FIG. 10. However, an analysis filterbank 704a (which may be or may not be the same of the analysis filterbank 704) may provide a filterbank domain version 729 of the input audio signal representation 702. The filterbank domain version 729 may be downmixed at a downmix stage 1700a. The downmix stage 1700a may include a downmix unit 730 (e.g. down mixer or downmixer), to obtain a downmixed version 732 (in the filterbank domain) of the HOA signal 702. The downmixed version 732 may have one single transport channel, or multiple transport channels, according to the particular downmix carried out. The downmixed version 732 of the HOA signal 702 may be subjected to a synthesis filterbank 734, to thereby obtain transport channels 501 (e.g., downmix, compressed version 736 of the HOA signal 702 in the time domain). The synthesized version 736 (which may or may not be a FOA signal, but in any case in less channels than the original signal 702) of the downmixed version 732 (compressed transport channel(s)) of the audio signal 702 may then be provided, as version 736, to one or more instances of an EVS coder 738 or any other mono audio coder. The transport channel(s) 501 (736) may be e.g. stored and/or transmitted, together with the side information 503, and to form a compressed version of the ambisonic spatial audio signal representation 502. Notably, however, the compressed ambisonic spatial audio signal representation 502 may comprise, beside the side information 503, any of the compressed (downmixed) versions 732, 736, 739.

The filtered input signal 729 may be downmixed, and mixing information or covariance information may be provided to the audio signal representation decoding unit (e.g. in the at least one transport channel), but this is not in all examples. In some cases, that will be discussed below, the audio signal representation decoding unit (e.g. 500b, see below) can reconstruct the mixing information even if covariance information is not written in the bitstream (coded signal) 802.

The filterbank domain version 729 of the input audio signal representation 702 may be downmixed at a downmix unit 730, to obtain a downmixed version 732. The downmixed version 732 may be subjected to a synthesis filterbank 734. The synthesized version 736 of the downmixed version 732 of the audio signal 702 may then be provided to the EVS coder 738. Then, the compressed transport channels 736 may be encoded by one instance of the EVS coder 738 or any other mono audio coder in block 738, to obtain at least one encoded transport channel 739 (encoded version of the compressed transport channel 736,). The compressed transport channel(s) 739 may be e.g. stored and/or transmitted, together with the side information 503, and to form a compressed version 502 (in the coded signal or bitstream 802) of the ambisonic spatial audio signal representation 502.

It is to be noted that the “compressed transport channel 736, 501” may or may not be an instantiation of the “at least one transport channel 501” of the “compressed ambisonic spatial audio signal representation 502” (which may be decompressed, for example, in FIG. 5a). If the at least one transport channel 736 is compressed, it must be decompressed (upmixed) by an upmixing unit (550, see below in FIG. 5b) to recover the transport channel(s) of the compressed ambisonic spatial audio signal representation 502. The fact that it is further compressed increases the efficiency.

A downmix-matrix calculator 726 may provide a downmix matrix 728 to the downmix unit 730. The downmix-matrix calculator 726 may make use of covariance information (e.g. covariance matrix) detailed below to perform an inter-channel prediction. The downmix-matrix calculator 726 could be more in general called “downmix-information calculator”, but, for the sake of simplicity, “downmix-matrix calculator” will be preferred.

The version 732, 736, or 739 of the ambisonic spatial audio signal representation 702 may be provided to a bitstream writer (muxer, encoded signal coder) (coded signal coder) 750 to provide the compressed ambisonic spatial audio signal representation 502 (bitstream, coded signal) to an external device (e.g. by transmission) or a storage unit.

The downmix unit 730 may apply the sound field parameters (sector diffuseness parameters, directional parameter(s) (529, 549, 718) providing information on a direction of arrival, DoA, for each parameters, etc.) to perform the downmixing. For this goal, the downmix unit 730 may make use of the downmix matrix 728, which may be outputted by a downmix matrix calculator 726. The downmix matrix calculator 726 may obtain the downmix matrix 728 from a covariance matrix (or more in general, a covariance information) which is, in turn, estimated from the sound field parameters 718 or their quantized versions 722. As can be seen, in fact, the downmix matrix calculator 726 is shown as being inputted with an input 722 including the sound field parameters 718 (e.g. in quantized form, but in other cases they could be in non-quantized form, e.g. 718 or 714, e.g. including 7141, 7142, . . . , 714n). The downmix matrix calculator 726 may or may not perform the same operations of a mixing matrix estimator 100 discussed below at the decoder side (and in particular, of the covariance matrix synthesizer 102 and a mixing matrix constructor 106 of FIG. 5b). The downmix unit 730 may in principle be considered to correspond of the upmixing block 110 of FIG. 5b (but in the two cases, the matrixes are not corresponding with each other).

Operations at the downmix matrix calculator 726 are now discussed. The downmix matrix (or more in general downmix information) may be obtained from covariance matrix (or more in general covariance information). Hence, first, how to obtain the covariance matrix (or covariance information) is discussed.

At first, the inter channel covariance matrix C may be defined. The inter channel covariance matrix C may be a squared (L+1)²×(L+1)² matrix (i.e. with (L+1)² rows and (L+1)² columns) given that L is the order of the ambisonic signal in the version 501 to be inputted in the decoder 500 (or the version 501c to be inputted in the portion 500 of the decoder 500b, see below in respect of FIG. 5b) (e.g. for a FOA signal, L=1 and there will be (L+1)²=4 rows and (L+1)²=4 columns). Each of the (L+1)² columns and each of the (L+1)² rows of the covariance matrix corresponds to one of the (L+1)² ambisonic channels according to a predefined order, so that an entry gives the covariance between the ambisonic channel corresponding to the row and the ambisonic channel corresponding to the column. Here, the generic matrix element will be indicated with C_{lm,l′m′}. With, for example, an FOA signal, this would be l equal to 0 or 1, and m=0 for m=0, and m=−1, 0, +1 for l=1, which brings to four combinations and a 4×4 covariance matrix. The covariance matrix may be a symmetrical matrix. Each non-diagonal element of the covariance matrix provides a covariance information between the two ambisonic channels. In general terms, the more two ambisonic channels are correlated, the higher the covariance in the corresponding matrix elements, while the more two ambisonic channels are uncorrelated, the lower the covariance in the corresponding matrix elements. For a non-diagonal matrix element, the element C_{lm,l′m′} between the ambisonic channel of the degree and index l and m, respectively, and that with the degree and index m′ and n′, respectively, may be

$${C}_{lm , {l}^{′} {m}^{′}} = ( 1 - Ψ ) \text{} * {E}_{x} * \text{} {a}_{1}^{2} * \text{} {Y}_{lm} ( {Ω}_{1} ) * \text{} {Y}_{{l}^{′} {m}^{′}} ( {Ω}_{1} ) + ( 1 - Ψ ) * {E}_{x} * {a}_{2}^{2} * {Y}_{lm} ( {Ω}_{2} ) * {Y}_{{l}^{′} {m}^{′}} ( {Ω}_{2} )$$

where Eₓ is the signal energy, Ω₁ and Ω₂ are the first and second directional parameters (e.g. sector DoAs), respectively, and “a₁” and a₂ may be the coefficient

$${a}_{1} = \frac{1 - {Ψ}_{1}}{1 - {Ψ}_{1} + 1 - {Ψ}_{2}} and {a}_{2} = \frac{1 - {Ψ}_{2}}{1 - {Ψ}_{1} + 1 - {Ψ}_{2}} = 1 - {a}_{1} ,$$

as discussed above, e.g. indicating the relative directivity of the audio signal 702 in the spatial sector in respect to the directivity of the signal for the totality of sectors, Ψ is the global diffuseness parameter, and Yₗₘ(Ω₁), Y_{l′m′}(Ω₁), Yₗₘ(Ω₂), and Y_{l′m′}(Ω₂) are the spherical harmonics evaluated onto the DoAs for each sector and for each ambisonic channel. This is valid in case of two spatial sectors.

Since in the diagonal matrix elements (l=l′, m=m′) there is no covariance, the generic diagonal matrix element may be written as

$${C}_{lm , lm} = ( 1 - Ψ ) * {E}_{x} * {a}_{1}^{2} * {Y}_{lm}^{2} ( {Ω}_{1} ) + ( 1 - Ψ ) * {E}_{x} * {a}_{2}^{2} * {Y}_{lm}^{2} ( {Ω}_{2} ) + Ψ * {σ}^{2} * {E}_{x}$$

with the same meanings of the symbols, and σ² is a predetermined energy scaling factor.

A more compact representation is

$${C}_{lm , {l}^{′} {m}^{′}} = ( 1 - Ψ ) \text{} * \text{} {E}_{x} * \text{} {a}_{1}^{2} * \text{} {Y}_{lm} ( \text{} {Ω}_{1} ) * \text{} {Y}_{{l}^{′} {m}^{′}} ( \text{} {Ω}_{1} ) + ( 1 - Ψ ) * \text{} {E}_{x} * \text{} {a}_{2}^{2} * \text{} {Y}_{lm} ( \text{} {Ω}_{2} ) * \text{} {Y}_{{l}^{′} {m}^{′}} ( \text{} {Ω}_{2} ) ++ \text{} Ψ * {σ}^{2} * {E}_{x} * {δ}_{lm , {l}^{′} {m}^{′}}$$

where δ_{lm,l′m′} is the Kronecker delta being 1 at the diagonal of the inter-channel covariance matrix and 0 outside the diagonal of the inter channel covariance matrix.

The covariance matrix may include:
1) in non-diagonal elements C_{mn,m′n′}, for each spatial sector, a component obtained by a product between:
   a. the non-global-diffuseness energy (1−Ψ)*Eₓ of the audio signal
   b. the spherical harmonic, evaluated on a first DoA Ω₁ and scaled by the relative directivity of the spatial sector over the sum of the directivities of the other spatial sectors
   c. the spherical harmonic, evaluated on the second DoA Ω₁ and scaled by the relative directivity of the spatial sector over the sum of the directivities of the other spatial sectors
2) in diagonal elements C_{mn,mn}:
   a. for each spatial sector, a component obtained by a product between:
      i. the non-global-diffuseness energy (1−Ψ)*Eₓ of the audio signal
      ii. a directivity energy a₁²*Yₗₘ² (Ω₁) (respectively a₂²*Yₗₘ² (Ω₂)) for each sector
   b. a global component scaling the global diffused energy Ψ*Eₓ by a predefined scaling factor σ².

The inter-channel covariance matrix C (with the elements C_{mn,m′n′}) may therefore be estimated from the sound field parameters 722, including Ωₛ, Ψ, Ψₛ for all s, where s=1 . . . n is the sector index, at the downmix calculator 726.

This inter-channel covariance matrix, in turn, allows to derive the downmix matrix and the upmix matrix in the audio signal representation encoding unit and the audio signal representation decoding unit, respectively. Therefore, a step of encoding the covariance matrix in the bitstream 502 may advantageously be skipped. Specifically, the downmix matrix calculator 726 may be configured to perform an inter-channel prediction (among the ambisonic channels). This prediction is based on the inter-channel covariance matrix 732 (the inter-channel covariance matrix 732 being derived from the directional parameters and sector diffuseness parameter(s) for each spatial sector and a global diffuseness or one or more parameters a indicative of a ratio or relationship between the diffuseness or diffuse energy of one sector to the diffuseness or diffuse energy of all sector) and can achieve an energy compaction among the audio channels 729.

In the audio signal representation encoding unit, the downmix matrix may with, for example, an FOA input signal be derived from the covariance matrix C_{mn,m′n′}, e.g. via the formula

$$D = ( \begin{matrix}1 & 0 & 0 & 0 \\ - {C}_{1 - 100} / {C}_{00 , 00} & 1 & 0 & 0 \\ - {C}_{11 , 00} / {C}_{00 , 00} & 0 & 1 & 0 \\ - {C}_{11 , 00} / {C}_{00 , 00} & 0 & 0 & 1\end{matrix} ) .$$

Additional terms may or may not enter the matrix in order to model uncorrelated signals using decorrelators in the decoder.

Reference is now made to the audio signal representation decoding unit 500b (FIG. 5b), which may comprise a portion 500 (the portion 500 being identical to the audio signal representation decoding unit 500 of FIG. 5a, and is therefore indicated with the same numeral 500). In FIG. 5b, the transport channel(s) 501 is converted from the downmixed, compressed version 501b onto an upmixed version 501c (but still compressed, at least in the sense of being a FOA version), and is provided to the portion 500, thereby providing the transport channels 501. Therefore, in the portion 500, the audio signal representation decoding unit 500b of FIG. 5b operates identically to the audio signal representation decoding unit 500 of FIG. 5a, to provide the decompressed ambisonic spatial audio signal representation 562.

In the audio signal representation decoding unit 500b (FIG. 5b), the mixing-matrix reconstructor 106 (see below) calculates the upmix matrix (mixing matrix) 108 as the inverse of the downmix matrix, which may, in turn, be calculated from the inter-channel covariance matrix 104. This can also happen via the use of a pre-defined formula derived to provide the inverse of the downmix matrix 728.

More in general, the covariance information may be based on an energy weighted by the spherical harmonics evaluated at the DoAs (e.g. Ω_1 . . . Q_{N}) and mixing weights a₁ . . . a_{N} for each spatial sector.

More in general, instead of the covariance matrix, covariance information may be used, e.g. together with global diffuseness information (e.g. global diffuseness parameter Ψ, or other information on the global diffuseness of the audio signal).

FIG. 5b shows an example of an audio signal representation decoding unit 500b generating a decompressed ambisonic spatial audio signal representation 562 e.g. from the downmixed transport channel(s) 501 in the compressed ambisonic spatial audio signal representation 502 inserted in the bitstream 802 (coded signal) e.g. by the audio signal representation decoding unit 700 of FIG. 7. Here, the at least one downmixed transport channel 501 of the compressed ambisonic spatial audio signal representation 502 may be a FOA, compressed downmixed version of the input audio signal 702.

FIG. 5b shows an example of the audio signal representation decoding unit 500b, which includes, together with the block 500 of FIG. 5a, also an upmixing unit 550. The upmixing unit 550 may receive, from the bitstream 802 (coded signal), the side information 503 (e.g. at least some of Ψ₁, Ψ₂, a₁, a₂, Ω₁, Ω₂ . . . ) and the at least one transport channel 501b. The at least one transport channel 501b may be an example of the at least one transport channel 501 corresponding to the transport channel(s) 501 upstream to the EVS coder 738. However, in this case, the at least one transport channel 501b (501) is upmixed so as to present a greater number of transport channels. The at least one transport channel 501b (501) may be received from the bitstream 802 as encoded transport channel 739, and may be decoded by an EVS decoder 738b (if the encoder 700 lacks the EVS encoder 738, the EVS decoder 738b may be avoided). The upmixed transport channels are therefore indicated with 501c, which is also an example of transport channels 501. In this case, however, the upmix is performed from the side information 503 (a directional parameter, sector diffuseness parameters, and global diffuseness), which are already discussed above.

As can be seen in FIG. 5b, a covariance matrix synthesizer 102 may receive the side information 503, including directional parameters Ω₁, Ω₂, . . . , second diffuseness parameters Ψ₁, Ψ₂, (or in the form of relative directionalities a₁, a₂, etc.) . . . , and global diffuseness information for other information, which permits to derive the global diffusion. Here, the covariance matrix synthesizer 102 may therefore obtain an inter-channel covariance matrix 104 (see above). The inter-channel covariance matrix 104 may include information on the covariance between the different ambisonic channels. In alternatives, covariance information may be derived. The covariance matrix may be estimated as at the encoder 700, and is therefore not repeated here.

Basically, the inter-channel covariance matrix 104 may be obtained as the covariance matrix C_{lm,l′m′}=(1−Ψ)*Eₓ*a₁²*Yₗₘ(Ω₁)*Y_{l′m′}(Ω₁)+ (1−Ψ)*Eₓ*a₂²*Yₗₘ(Ω₂)*Y_{l′m′}(Ω₂)+Ψ+σ²*Eₓ*δ_{lm,l′m′}, as described above.

The inter-channel covariance matrix 104 may then be provided to a mixing matrix reconstructor 106, which reconstructs the mixing matrix 108 according to the number of transport channels that are to be in the version 501c of the transport channel 501b. Once the mixing matrix 108 is obtained by the mixing matrix reconstructor 106, an upmixing block 110 may use the mixing matrix 108 and apply it to the transport channel(s) 501b, to convert them into a transport channel version 501c (501) (e.g. in multiple channels, e.g. represented as a FOA signal, e.g. with four channels) to be provided to block 500 of FIG. 5a. The sound field parameters 503 are also provided to the block 500.

It is to be noted that the technique of 500b may be skipped in the cases in which either the inter-channel covariance matrix or the mixing matrix is written in the bitstream 802 or is obtained in another way. The covariance matrix synthesizer 102 and the mixing matrix reconstructor 106 form, together with each other, a mixing matrix estimator 100. Notably, other techniques may be used for obtaining the mixing matrix.

The operations above may be performed band by band. Reference is made to FIG. 5c (showing a variant 500b′ of FIG. 5b). The audio signal representation decoding unit 500b′ may comprise a band combiner 570. The band combiner 570 may combine the covariance-related information 104 (from the bitstream 802 and/or from the covariance-matrix synthesizer 102) such that part of the covariance information 104a comes from the bitstream 802 for some bands, while other covariance information 104 comes from the covariance-matrix synthesizer 102 for the other bands. It is to be noted, however, that some parameters (e.g. sound field parameters, such as DoAs, and/or diffuseness parameter(s)) may be the same for groups of bands. Moreover it is understood that the covariance information 104 in the bitstream 802 can contain the covariance matrix elements directly or any other representation derived from them. For example, prediction coefficients or decorrelator-channel weights can be such representations. In general, different representations can be mixed.

The mixing matrix 108 may be reconstructed for each band (e.g. in the example 500b of FIG. 5b). However, in some examples (e.g. in the variant 500b′ of FIG. 5c), for some bands, the entries of the mixing matrix 108, or other parameters encoding the covariance or prediction information, may be encoded in the side information 503, while for other bands they are skipped. This is done (e.g. in the variant 500b′ of FIG. 5c) in the band combiner unit 595, which provides the entries of the mixing matrix 108 as 104a. Here, it may be that the sector directional parameter(s) and the sector diffuseness parameter(s) (e.g. relative directionalities) are used to retrieve the mixing matrix 108 through the covariance matrix only for some bands (e.g. high frequency bands), while for other bands (e.g. lower frequency bands), the entries of the mixing matrix 108 (or of the mixing information) may be written in the side information parameters 503. For example, the sound field models (i.e. to retrieve the covariances from the sound field parameters) could be employed only in high frequency bands, where the perceptual impact of inaccuracies is lesser.

It is also to be noted that in some examples it is possible (e.g. at the audio signal representation decoding unit) to switch between:
a low order operation mode, in which, among the plurality of sector decoding paths (521, 541), at least one of the sector decoding paths (521, 541) is deactivated, while only one of the sector decoding paths (521, 541) is activated, wherein the side information (503) does not contain the sound field parameter(s) (549) for the deactivated at least one of the sector decoding paths (521, 541); and
a high order operation mode, in which, among the plurality of sector decoding paths (521, 541), all the plurality sector decoding paths (521, 541) are activated, or at least less sector decoding paths are deactivated in respect to the low order operation mode, wherein the side information (503) also contains the sound field parameter(s) (529, 549) for all the plurality of the sector decoding paths (521, 541), as well as the global diffuseness parameter (507, 509).

In some examples, the side information 503 may include the global diffuseness parameter in the low order operation mode, as well.

It is also to be noted that in some examples it may possible (e.g. at the audio signal representation encoding unit, e.g. 700 or 700b) to switch between:
a low order operation mode, in which, among a plurality of sector paths, at least one of the sector paths is deactivated, while only one of the sector paths is activated, so that the side information does not contain the sound field parameter(s) for the deactivated at least one of the sector paths (the global diffuseness parameter may also be encoded in the side information); and
a high order operation mode, in which, among the plurality of sector paths, all the plurality sector paths are activated, or at least less sector paths are deactivated in respect to the low order operation mode, so that the side information also contains the sound field parameter(s) for all the plurality of the activated sector paths, as well as the global diffuseness parameter.

(In FIG. 7 or 10, a first sector path may include a series formed by blocks 7071, 7121, providing the sector parameter set 1, 7141; a second sector may include a series formed by blocks 7072, 7122, providing the sector parameter set 2, 7142; an n-th sector path may include a series formed by blocks 707n, 712n, providing the sector parameter set n, 714n in the side information).

For example, e.g. at the audio signal representation encoding unit (e.g. 700 or 700b), in the low order operation mode, it could be that only the sector parameter set 1 (7141) is provided, while in the high order operation mode both the second parameter sets 1 and 2 (and maybe also n) are provided in the side information, and also the global diffusion parameter 7149 (507) may be provided in the side information (in examples, the global diffusion parameter may be provided in the side information both in the high order operation mode and in the low order operation mode).

In some examples, the choice between the low order operation mode and the high order operation mode may be made by the audio signal representation encoding unit (e.g. 700 or 700b) and signaled in the side information 503 of the bitstream 802, and the audio signal representation decoding unit (e.g. 500, 500b, 500b′), after retrieving the signaling in the side information 503, will also switch accordingly to the low order operation mode or high order operation mode as under the control of the (signaling.

Optionally, the selection between the low order operation mode and the high order operation mode may be static or depend on the bitrate.

In some examples the switching (e.g. selecting between the low order operation mode and the high order operation mode) is only for some bands, while in some other examples the switching is for all the bands.

Accordingly, a satisfactory tradeoff can be obtained between keeping the band low overhead (by reducing the side information 503) and a quality for the most important bands.

Optionally, the selection between the low order operation mode and the high order operation mode may be static or depend on the bitrate.

In a mobile communications scenario, for example, the available bitrate may depend on the quality of the network connection, which can vary over time. Hence, according to examples the audio signal representation encoding unit (e.g. 700, 700b) and/or the audio signal representation decoding unit (e.g. 500, 500b, 500b′) may switch dynamically between different bitrates. The audio signal representation encoding unit and/or the audio signal representation decoding unit may be configured to select, at high bitrates (e.g. at bitrates over a predetermined bitrate threshold), the high order operation mode, and/or to select, at low bitrates (e.g., the above-mentioned predetermined bitrate threshold), the low order operation mode (the low bitrates are lower than the high bitrates). The quality may be measured, for example, from the measurements related to the quality of the network connection. (E.g., quality may be measured through latency measurements, in such a way that the higher the average latency of one or more messages, the lower the quality; and the lower the average latency of one or more messages, the higher the quality; in this case, the predetermined quality-related threshold is a latency threshold, so that the higher bitrates are chosen for lower average latencies, and lower bitrates are chosen for higher average latencies. Or quality may be measured through error-rate measurements, e.g. based on the check of the CRC field of messages, in such a way that the higher the number of incorrect messages received, the lower the quality, and the lower the number of incorrect messages received, the higher the quality; in this case, the predetermined quality-related threshold may be an incorrect messages threshold (error rate threshold), such as that the higher bitrate is chosen for a number of incorrect messages which is below the incorrect messages threshold, and the lower bitrate is chosen for a number of incorrect messages which is above the incorrect messages threshold. Or quality may be measured through connection-bandwidth measurements, e.g. based on the average connection bandwidth. In this case the predetermined quality-related threshold may be a bandwidth threshold, so that the higher bitrates are chosen for higher average bandwidth, and lower bitrates are chosen for lower average bandwidth.) The measurements related to the quality of the network connection may be obtained, for example, by cooperation of the audio signal representation encoding unit (e.g. transmitter) with the audio signal representation decoding unit (e.g., receiver). For example, the error rate may be measured by the audio signal representation decoding unit (receiver) and its value may be encoded and provided in feedback to the audio signal representation encoding unit. Also latencies may be measured by the audio signal representation encoding unit (e.g. transmitter) in receiving a response to a particular pilot signal sent at particular time instants, and measuring the time of the reception of a particular response signal sent by the audio signal representation decoding unit (e.g., receiver) in response to the reception of the particular pilot signal. By subtracting, from the time instant of the transmission of the particular pilot signal, the time instant of the reception of the particular response signal, the latency may be calculated. Another way, for the audio signal representation encoding unit (e.g. transmitter), for obtaining latencies may be, for example, reading a time stamp in a message from the audio signal representation decoding unit (e.g., receiver), so as to determine the latency of that message. Or, measurements of the connection bandwidth can be performed. Other quality-related measurements can be carried out. Therefore, the selection between the high order operation mode and the low order operation mode may be based on measurements of the quality of the network connection.

In examples, in the audio signal representation encoding unit (e.g. 700, 700b), the bitrate may be, for example, selected by the user or by a preselection (e.g., a default preselection), or automatically depending on the quality of the network connection (e.g., in such a way that the lower quality, the lower bitrate; and the higher the quality, the higher the bitrate). The audio signal representation encoding unit may then select between the high order operation mode and the low order operation mode depending on the bitrate (e.g., the bitrate being below a predetermined bitrate threshold, indicative of a low quality, implying the selection of the low order operation mode; and the bitrate being above the predetermined bitrate threshold, indicative of a high quality higher than the low quality, implying the selection of the high order operation mode).

At the audio signal representation encoding unit (e.g. 700, 700b), the selection of the operation mode between the low order operation mode and the high order operation mode may, for example, depend (partially or completely) on the input audio signal (e.g. totally on the input audio signal or at least on the input audio signal). When a high order input signal is available, the high order operation mode can be selected. When only a low order input signal is present, the audio signal representation encoding unit can switch back to the low order operation mode.

In another example, the audio signal representation encoding unit (e.g. 700, 700b) may be configured to select the high order operation mode when the battery supplying the audio signal representation encoding unit (e.g. the battery of a user equipment comprising the audio signal representation encoding unit) is fully charged (or at least charged over a predetermined charge threshold, or battery supply threshold), and to select the low order operation mode when the battery is not fully charged (or at least charged below the predetermined charge threshold, or battery supply threshold), e.g. when in a power saving mode.

The bitrate selected by the audio signal representation encoding unit (e.g. 700, 700b) is detected by the audio signal representation decoding unit. For example, the audio signal representation decoding unit (e.g. 500, 500b, 500b′) may select the high order operation mode when a high bitrate is received (e.g. above a predetermined bitrate threshold), and the audio signal representation decoding unit (e.g. 500, 500b, 500b′) may select the low order operation mode when a lower bitrate (e.g. below the predetermined bitrate threshold) is received.

In another example, the audio signal representation decoding unit (e.g. 500, 500b, 500b′) may select the high order operation mode when it is signaled in the bitstream (e.g. among the side information 503) that a high order audio signal has been encoded by the audio signal representation encoder, and the audio signal representation decoding unit may select the low order operation mode when it is signaled in the bitstream (e.g., in 503) that a low order audio signal has been encoded by the encoder.

In some other examples, the audio signal representation decoding unit (e.g. 500, 500b, 500b′) may request a high bitrate from a network and select the high order operation mode, or the audio signal representation decoding unit may request a low bitrate from a network and select the low order operation mode. The selection of the bitrate may, for example, depend on a user setting (or preselection, such as a default preselection) or the capabilities of a user equipment which comprises the audio signal representation decoding unit.

In examples above, the sound field parameters may be modified to achieve a rotation of the sound field represented by the output ambisonic signal (502). The DoAs may contain the direction where the sound comes from. This because if it is required to achieve a rotation of the sound field (e.g. for head tracking), the audio signal representation decoding unit modify those parameters and save the complexity of an extra rotation step. The audio signal representation decoding unit will therefore operate according to the parameters' modifications.

Here below some examples are provided on the evolution of the audio signal representation 702 in FIG. 7:

In the audio signal representation encoding unit 700:
1) The uncompressed audio signal representation 702 may be, for example, a HOA signal, e.g. in time domain, having more than four channels;
2) In the downmix stage 1700a:
   a. In the filterbank analysis block 704a, the uncompressed audio signal representation 702 may be converted into the filterbank domain version 729;
   b. In the downmix unit 732, the filterbank domain version 729 may be converted into the downmixed (compressed) version 732;
   c. After the filterbank synthesis block 734, the downmixed (compressed) version 732 may be converted into a time domain version 736 (notably, the downmix version 732 may have one single transport channel, or a plurality of transport channel)
3) In the EVS coder, the compressed, downmixed version 736 in the time domain may be converted into an encoded version 739
4) In the bitstream writer (e.g. muxer) 750, the bitstream 802 is written.

Meanwhile, the HOA signal 702 may be processed to obtain the sound field parameters 718, including the sector directional parameters and the sector diffuseness parameters. From the sound field parameters 718, the covariance matrix and the downmix matrix 728 may be calculated, so as to permit the downmix at 730. In addition, a quantized representation of the sound field parameters is written to the bitstream (802) in the bitstream writer (muxer) (750).

In the apparatus 800 of FIG. 8 (including the audio signal representation decoding unit 500b of FIG. 5b or 500b′ of FIG. 5c):
1) The bitstream 802 is read by the bitstream reader and dequantizer 804 as encoded, compressed ambisonic spatial audio signal representation 502 (502b);
2) From the bitstream 502 (502b), the at least one encoded transport channel 739 (501) is obtained;
3) In the EVS decoder 738b, the at least one encoded transport channel 739 (501) is converted into the compressed, downmixed at least one transport channel 501b (corresponding to the transport channel 736 in FIG. 7);
4) In the upmixing block 110, through the mixing information (e.g. mixing matrix) 108, the at least one transport channel 501b is upmixed to transport channels 501c (501) (e.g. four FOA channels)
5) In the portion 500 of the audio signal representation decoding unit 500b (totally corresponding to the audio signal representation decoding unit 500 of FIG. 5a), the four FOA channels 501 are split at splitter block 504, among the FOA global diffuseness signal 506 (in the global diffuseness path 505) and the FOA globally non-diffused signal 520;
   a. In the in the global diffuseness path 505, the global diffuseness signal 506 is subjected to the gain provided by the energy compensation block 508 to thereby obtain the energy-compensated global diffuseness signal 510;
   b. In each of the sector decoding paths 521, 541, etc, the transport channels evolve first through the spatial filtering at spatial filtering stage 574, and then through the sector signal processor 572, to thereby obtain, for each spatial sector, a sector directional signal 532;
6) In the global diffuseness signal inserter 560, the sector directional signals 532, 552 and the energy-compensated global diffuseness signal 510 are added with each other, to derive the HOA decompressed ambisonic spatial audio signal representation 562;
7) The HOA decompressed ambisonic spatial audio signal representation 562 may then be either re-encoded as 816, or rendered as 814, or stored or transmitted as it is.

As explained above, the inter-channel covariance matrix 104 and the mixing matrix 108 may be reconstructed from the sound field parameters in the side information, to perform the upmix of the at least one transport channel 501b into the transport channels 501 (501c) to be fed to the portion 500 of the of the audio signal representation decoding unit 500b. Within the portion 500 of the of the audio signal representation decoding unit 500b, the same sound field parameters are also used for processing the transport channels in the paths 505, 521, and 541.

With reference to the example of the audio signal representation encoding unit 700b of FIG. 10 and the audio signal representation decoding unit 500 of FIG. 5a, it is mostly the same, with the difference that the downmix stage 1700a is performed by channel selection, no covariance matrix or downmix matrix is calculated and/or reconstructed, and the transport channel(s) 736 or 739 (e.g. four transport channels) are provided, as transport channel(s) 501, directly to the audio signal representation decoding unit 500, and in particular to the splitter 504.

In the examples, the audio signal representation encoding unit (e.g. 700, 070b, etc.) may be a transmitter or integrated in a transmitter (e.g., transmitting through a wired or wireless or mixed transmission, e.g. through geographical networks and/or local networks) and/or the audio signal representation decoding unit (e.g. 500, 500b, 500b′, etc.) may be receiver or integrated in a receiver (e.g., receiving through a wired or wireless or mixed transmission, e.g. through geographical networks and/or local networks).

### DISCUSSION

The invention uses the combination of first-order estimators and higher-order sector estimators for higher-order directional audio coding (HO-DirAC).

In particular, it makes use of the combination of both, global diffuseness and sector diffuseness, improving upon the state-of-the-art shown in FIG. 2.

The global diffuseness sets the direct-to-diffuse stream balance, noting that Ψ may be restored at the decoder (audio signal information decoding unit e.g. 500, 500b, 500b′, etc.). The decoder may receive Ψ from the bitstream or calculate it from the transport channels (501, 501c).

The decoder (audio signal information decoding unit e.g. 500, 500b, 500b′, etc.) in the direct-stream may extract the sector signals xₛ e.g. by beamforming (spatial/directional filtering) from the transmitted FOA signals according to the encoder sector design. The sector signals are obtained by

$${x}_{s} = {w}_{s}^{T} {x}_{L} ,$$

where wₙₘ is the beamforming weights vector for sector s, and x_{L} the FOA signal vector. From xₛ HOA signals are restored by continuing the SH plane-wave coefficients in direction of the sector DoA Ωₛ

$${x}_{s} = Y ( {Ω}_{s} ) * {x}_{s} = [ {x}_{s} {Y}_{00} , {x}_{s} {Y}_{1 - 1} , {x}_{s} {Y}_{10} , {x}_{s} {Y}_{11} , … ] .$$

The sectors (spatial sectors) are balanced based on the sector diffuseness ratio aₛ, therefore, less diffuse sectors contributing more to the directional stream. The sector ratio can be defined, e.g. for two sectors, as

$${a}_{1} = \frac{1 - {Ψ}_{1}}{1 - {Ψ}_{1} + 1 - {Ψ}_{2}} , {a}_{2} = 1 - {a}_{1} ,$$

where Ωₛ is the sector diffuseness estimated at the encoder.

The proposed design is flexible in terms of the number of sectors, with the only constrains Σₛxₛ=x₀₀; Σₛaₛ=1. This follows directly from amplitude preservation over sectors detailed in [Hold2021].

The restored directional part of HOA signal vector x_{H,s} for one sector s is

$${x}_{H , s} = ( 1 - Ψ ) * {a}_{s} * Y ( {Ω}_{s} ) * {x}_{s} .$$

The diffuse part is rendered as FOA signal vector, amplified by a gain factor dependent on the total diffuseness and the input order L and output order H, detailed in [WO 2020/115311 A1],

$$1 + g ( Ψ ) = \sqrt{1 + Ψ * ( \frac{H + 1}{L + 1} - 1 )} .$$

Summation over all HOA signal vectors and FOA signal vector results in the decoder output HOA signal vector.

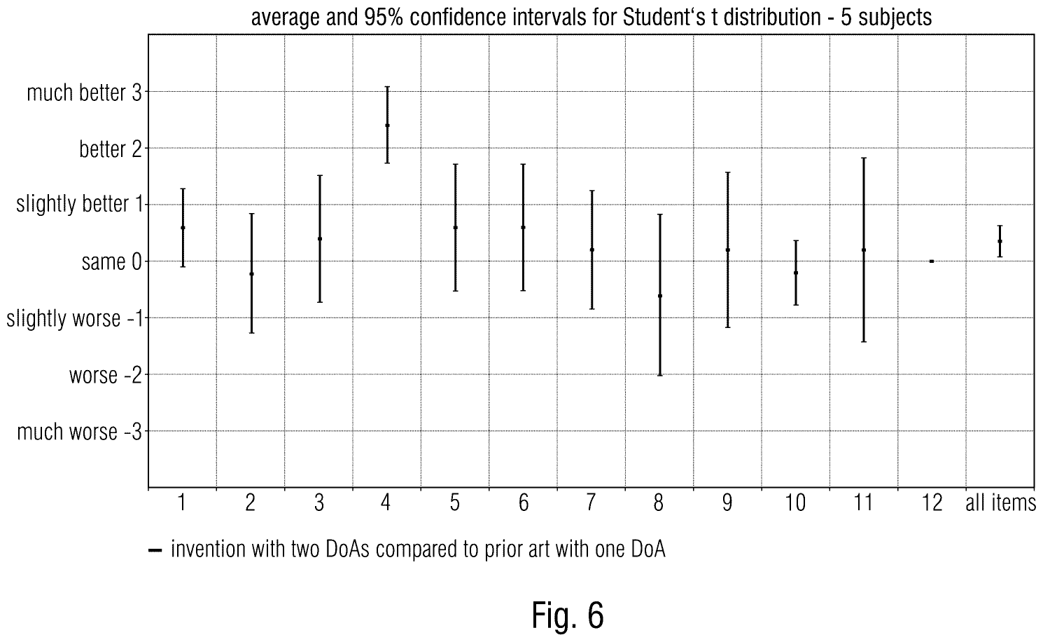

The proposed design with two DoAs and higher-order sector processing according to FIG. 5a can show significant improvements in a listening test over loudspeakers (CICP19), where the result is shown in FIG. 6. In particular, items like 4, which contains a sound scene with broad spatial distribution of surrounding rain drops with distinct localization, benefit significantly, as the spatial impression tends to collapse with the state-of-the-art method, which is improved upon in the proposed method. Other scenes tend to benefit, or not deteriorate with the proposed method.

Furthermore, the more accurate multi-DoA model of the directional signal allows for a more accurate estimation of the inter-channel covariance matrix Cₓ, which may be of

$${C}_{mn , {m}^{′} {n}^{′}} = ( 1 - Ψ ) * {E}_{x} * {a}_{1}^{2} * {Y}_{l m} ( {Ω}_{1} ) * {Y}_{{l}^{′} {m}^{′}} ( {Ω}_{1} ) + ( 1 - Ψ ) * {E}_{x} * {a}_{2}^{2} * {Y}_{l m} ( {Ω}_{2} ) * {Y}_{{l}^{′} {m}^{′}} ( {Ω}_{2} ) + + Ψ * {σ}^{2} * {E}_{x} * {δ}_{l m , {l}^{′} {m}^{′}}$$

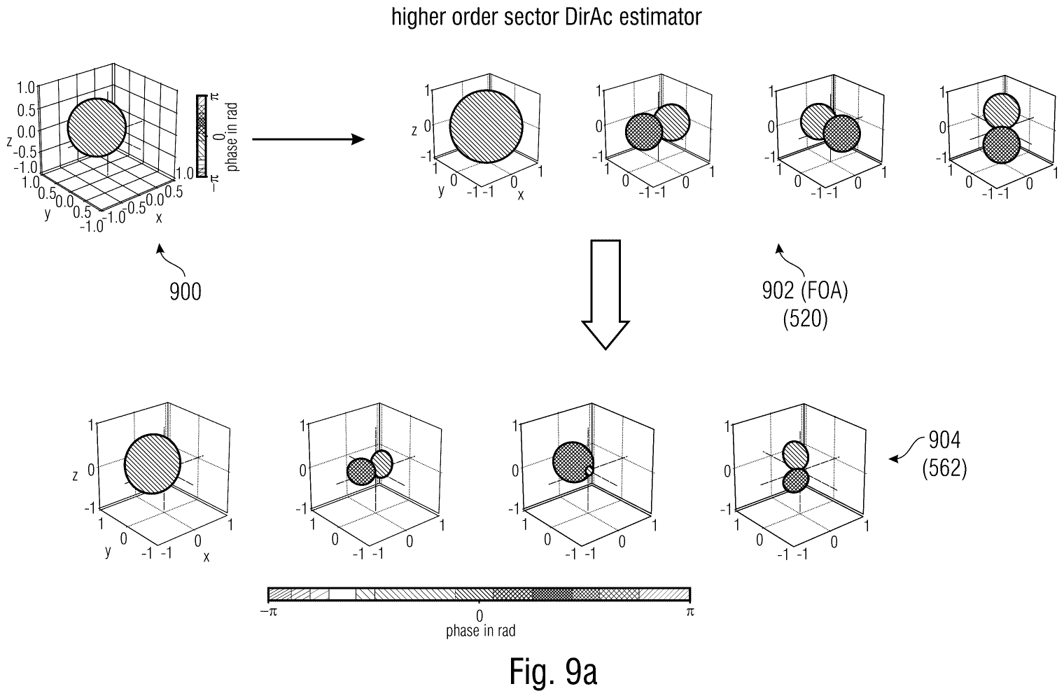

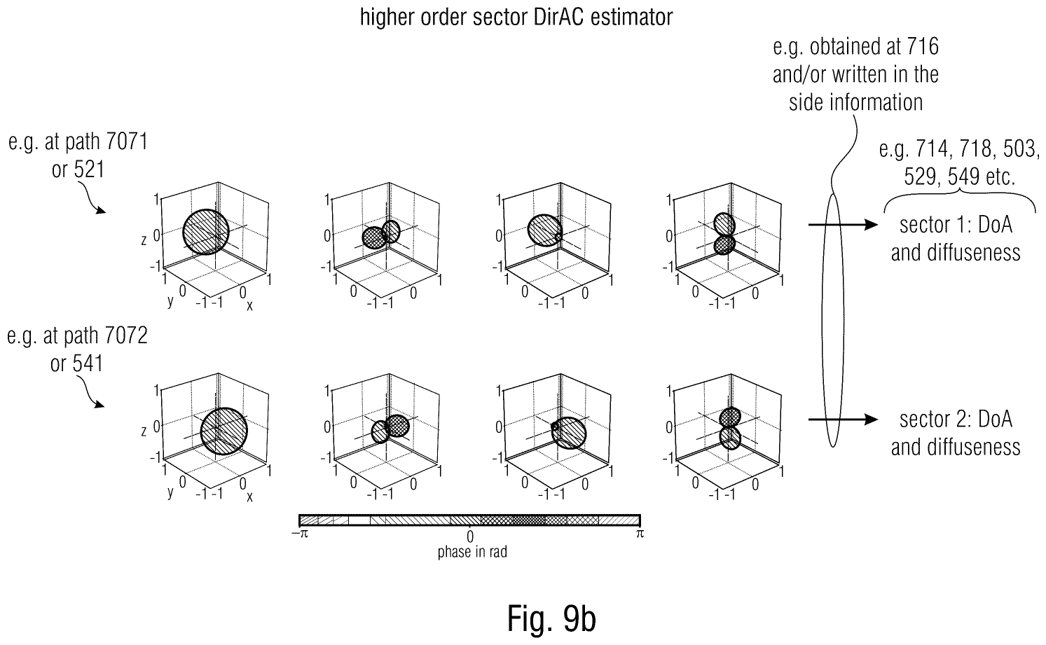

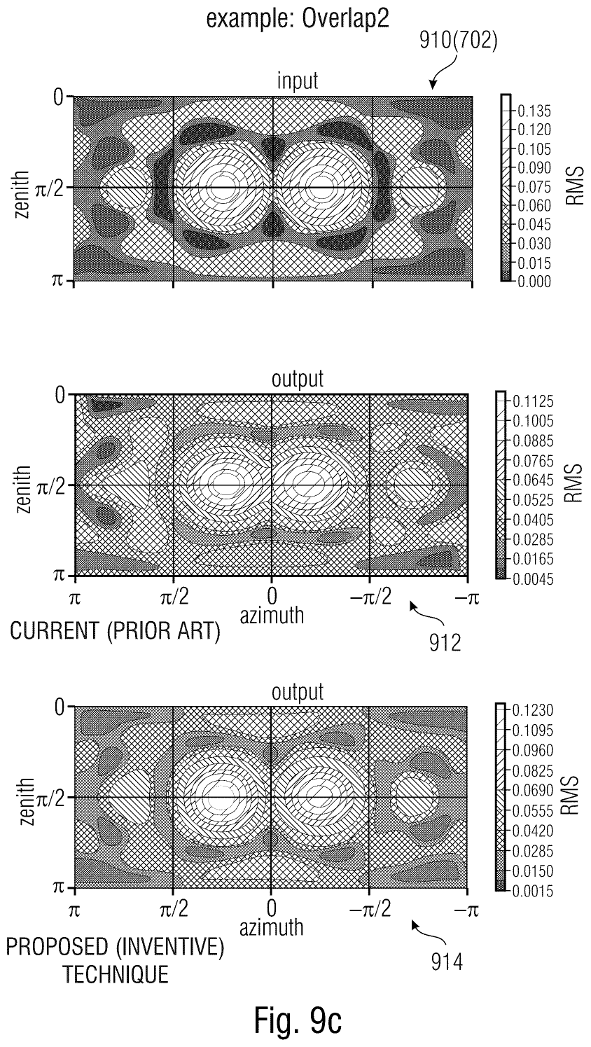

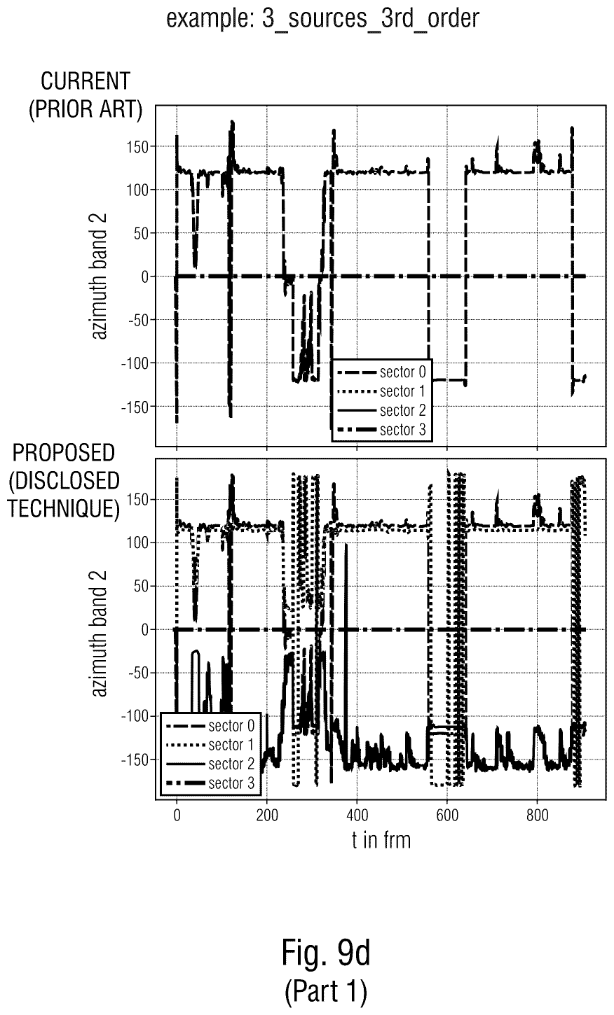

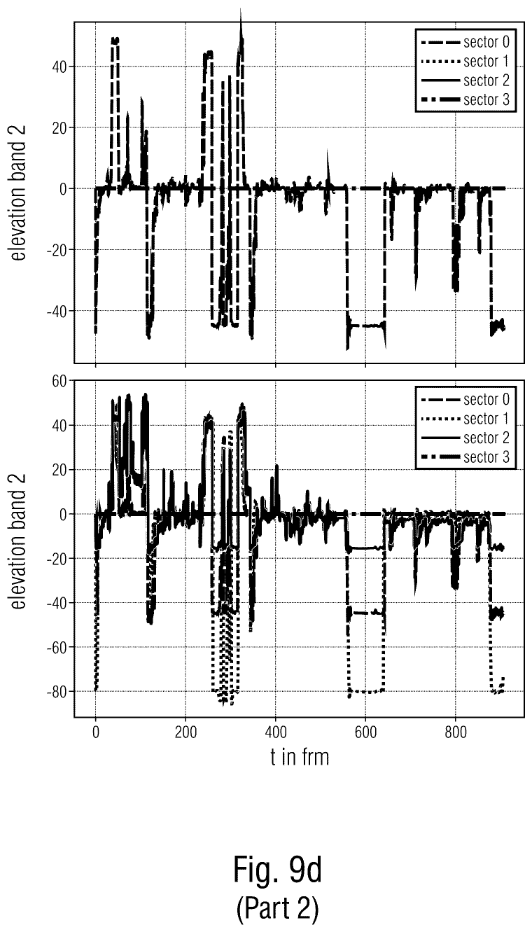

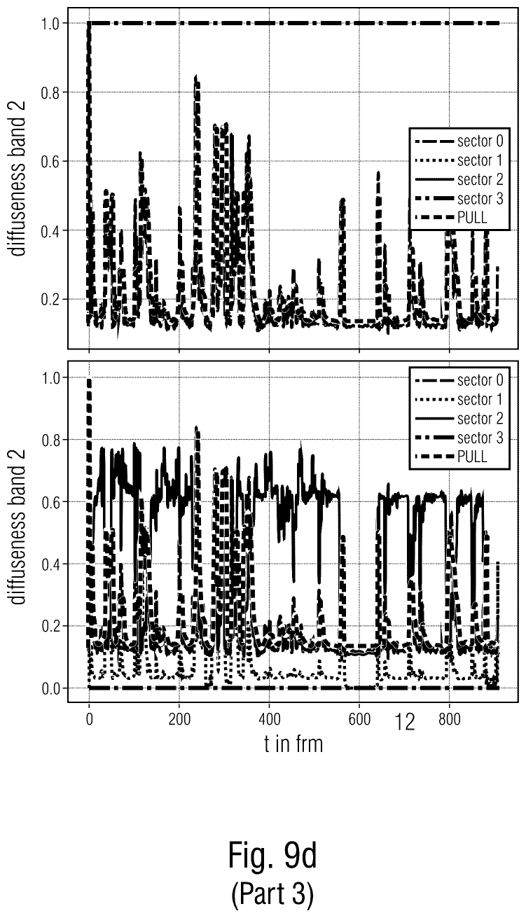

This will lead to a more efficient compression of the transport channels in the current IVAS system. In FIG. 9a, 900 refers to a sector beam of one spatial sector. The panel 902 shows four spherical harmonic functions that belong to the first channels (FOA) of an ambisonic signal (e.g. 501). The panel 904 shows filtered versions of these functions, where the sector beam from the first panel has been applied. Therefore, it can be understood as the contribution of the respective FOA channel to the filtered signal (528) of this specific sector.

FIG. 9b shows the same, but for two spatial sectors (e.g., s=1 and s=2).

FIG. 9c. shows the signal energy as a function of the DoA. The input signal (top panel) 910 is the reference and corresponds to the audio signal 702 (or a version thereof) encoded by the audio signal representation encoding unit 700. The proposed method provides an output signal 914 (which may correspond to the decoded representation 562 and/or on its rendered version 814) where the energy distribution is more similar to the reference signal 702, as compared to an output signal 912 (e.g. corresponding to the representation 262 of FIG. 2) according to the prior art with a single DoA. Specifically, the two independent sources at too directions are resolved much more clearly, as opposed to 912, where a lot of energy leaks into the region between the actual sources.

In the figures, ordinate and abscissa refer to zenith-coordinate and azimuth coordinate. RMS means root mean square of the signal energy.

FIG. 9d displays the direction and diffuseness parameters for four spatial sectors and the whole signal. The comparison between the upper and lower plots demonstrates that the inventive sector based method can resolve different DoAs and diffuseness values for different sectors. In contrast, other methods with only one sector can only resolve one DoA and one diffuseness.

The present disclosure also refers to an audio encoder which comprises the audio signal representation encoding unit (e.g. of FIG. 7 or 10) and a quantizer and bitstream writer (e.g., the element 40) which may write the compressed audio signal representation 502 in the bitstream.

### Aspects

Some aspects are here summarized.

In comparison to prior-art:
Sector processing, i.e. more than one DoA more than one diffuseness measure acting on sector beamfomer signals during reconstruction
   delta to [WO 2020/115311 A1])

Important novelty aspects:
Combination of total diffuseness (e.g. from first-order) and sector diffuseness ratio (e.g. from higher-order)
   delta to [U.S. Pat. No. 10,313,815B2], which is Loudspeaker rendering not HOA coding

### Details:

1 An apparatus parameterizing a spatial audio scene from higher order (HO) spherical harmonic domain (SHD) signals, i.e. higher-order Ambisonics (HOA).
   1a Transmitting a subset of the HOA input signals, such as but not limited to first-order Ambisonics (FOA), and the spatial parameterization as a set of metadata
   1b. Reconstructing the not transmitted HOA signal components by utilizing the transmitted metadata
   1c The metadata comprising of more than one direction of arrival (DoA)
   1d The combination of an overall sound-field diffuseness estimate, estimated from the first-order SHD, in conjunction with more than one sound-field spatially localized diffuseness measures, estimated from the higher-order SHD
   1e Psychoacoustic frequency weighting in the group averaging of the spatial parameterization
   2 An apparatus to reconstruct the HOA signal utilizing more than one DoA and both, the overall diffuseness measure and spatially localized sound-field diffuseness measures
   2a Re-estimating (parts) of the first-order parameters at the decoder
   2b Utilizing the parameters estimated from HOA signals to improve the performance of the reconstruction based on parameters estimated from FOA, thereby employing both, first-order and higher-order estimators
   3 Utilizing the sector parameterization, such as but not limited to more than one DoA to predict the HOA channel covariance (SPAR)

### Further Specification

Possible metadata (e.g. sound field parameters in side information 503)

Possible comparative examples:
Prior art: DoA and Diffuseness: [Ω, Ψ] (f)
Present technique: 2 DoAs, Diffuseness (but it can be estimated at decoder 500) and Sector Diffuseness-Ratio (or more in general sector diffuseness information, such as the relative directionality a₁): [Ω₁, Ω₂, (Ψ) a] (f)

Notably, it is possible to make use of the currently used infrastructure and signal coder (bitstream writer 802), and is transparent to the decoder 500.

Other important aspects:
1) Multi-DoA rendering using HO sectors (it needs to transmit only 2^{nd} set of DirAC pars, but it is possible to use the same audio channels)
2) It has been noted that the direct energy of the proposed HO design equals the direct energy in the prior art
3) Sector signal reconstruction at decoder relies on FOA signals (suitable for higher bitrates)
4) Utilizing existing coders
Multi DoA can improve covariance prediction and
decrease the residual C_{R}

$$C = {C}_{x} + {C}_{R}$$

$$Currently : {C}_{x} ∼ {[ {x}_{00} Y ( Ω ) ] [ … ]}^{T}$$

$$Proposed : {C}_{x} ∼ {[ a * {x}_{1} * Y ( {Ω}_{1} ) + ( 1 - a ) * {x}_{S 2} * Y ( {Ω}_{2} ) ] [ … ]}^{T}$$

### Further Implementations

Depending on certain implementation requirements, examples may be implemented in hardware. The implementation may be performed using a digital storage medium, for example a floppy disk, a Digital Versatile Disc (DVD), a Blu-Ray Disc, a Compact Disc (CD), a Read-only Memory (ROM), a Programmable Read-only Memory (PROM), an Erasable and Programmable Read-only Memory (EPROM), an Electrically Erasable Programmable Read-Only Memory (EEPROM) or a flash memory, having electronically readable control signals stored thereon, which cooperate (or are capable of cooperating) with a programmable computer system such that the respective method is performed. Therefore, the digital storage medium may be computer readable.

Generally, examples may be implemented as a computer program product with program instructions, the program instructions being operative for performing one of the methods when the computer program product runs on a computer. The program instructions may for example be stored on a machine readable medium.

Other examples comprise the computer program for performing one of the methods described herein, stored on a machine readable carrier. In other words, an example of method is, therefore, a computer program having a program instructions for performing one of the methods described herein, when the computer program runs on a computer.

A further example of the methods is, therefore, a data carrier medium (or a digital storage medium, or a computer-readable medium) comprising, recorded thereon, the computer program for performing one of the methods described herein. The data carrier medium, the digital storage medium or the recorded medium are tangible and/or non-transitionary, rather than signals which are intangible and transitory.

A further example comprises a processing unit, for example a computer, or a programmable logic device performing one of the methods described herein.

A further example comprises a computer having installed thereon the computer program for performing one of the methods described herein.

A further example comprises an apparatus or a system transferring (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some examples, a programmable logic device (for example, a field programmable gate array) may be used to perform some or all of the functionalities of the methods described herein. In some examples, a field programmable gate array may cooperate with a microprocessor in order to perform one of the methods described herein. Generally, the methods may be performed by any appropriate hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following ap-pended claims be interpreted as including all such alterations, permutations and equivalents as fall within the true spirit and scope of the present invention.

### REFERENCES

[US20100169103A1] Pulkki, Method and apparatus for enhancement of audio reconstruction
[Pulkki2007] Pulkki, V.: Spatial Sound Reproduction with Directional Audio Coding, J. Audio Eng. Soc, 2007, 55, 503-516
[Zotter and Frank] Ambisonics-A Practical 3D Audio Theory for Recording, Studio Production, Sound Reinforcement, and Virtual Reality, Springer, 2019
[WO 2020/115311 A1] Fuchs, Apparatus, method and computer program for encoding, decoding, scene processing and other procedures related to dirac based spatial audio coding using low-order, mid-order and high-order components generators
[U.S. Pat. No. 10,313,815B2] Kuech, Apparatus and method for generating a plurality of parametric audio streams and apparatus and method for generating a plurality of loudspeaker signals
[Politis2015] A. Politis, J. Vilkamo and V. Pulkki, “Sector-Based Parametric Sound Field Reproduction in the Spherical Harmonic Domain,” in IEEE Journal of Selected Topics in Signal Processing, vol. 9, no. 5, pp. 852-866, August 2015, doi: 10.1109/JSTSP.2015.2415762.
[Hold2021] Hold, Christoph, et al. “Spatial filter bank design in the spherical harmonic domain.” 2021 29th European Signal Processing Conference (EUSIPCO). IEEE, 2021.

What is claimed is:

1. An audio signal representation decoding unit for generating a decompressed ambisonic spatial audio signal representation from a compressed ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the audio signal representation decoding unit including a plurality of sector decoding paths, each sector decoding path being configured to decode a directional sector signal of the decompressed ambisonic spatial audio signal representation in each spatial sector by applying, to the at least one transport channel, or a sector signal derived from the at least one transport channel, the directional parameter(s) and the sector diffuseness parameter(s) of the spatial sector,
the audio signal representation decoding unit including a global diffuseness signal decoding path configured to derive a global diffuseness signal by applying, to the at least one transport channel, a global diffuseness parameter, or other information on the global diffuseness of the audio signal,
the audio signal representation decoding unit including a global diffuseness signal inserter to combine the plurality of decoded directional sector signals and the global diffuseness signal, to output the decompressed ambisonic spatial audio signal representation.

2. The audio signal representation decoding unit of claim 1, configured to apply, to the at least one transport channel or a sector signal derived from the transport channel, the sector diffuseness parameter(s) by weighting the transport channel, in at least one sector decoding path, using a mixing weight derived from the sector diffuseness parameter(s), to thereby derive the directional sector signal.

3. The audio signal representation decoding unit of claim 2, configured to weight the at least one transport channel or sector signal derived from the transport channel using the mixing weight being, or being derived from, a positive coefficient received from, or processed from, the sector diffuseness parameter(s).

4. The audio signal representation decoding unit of claim 2, configured to weight the at least one transport channel, or sector signal derived from the transport channel, using the mixing weight, for at least one spatial sector,
the mixing weight being, or being derived from, a coefficient indicative of a sector directionality in the specific spatial sector.

5. The audio signal representation decoding unit of claim 2, configured to weight the at least one transport channel or sector signal derived from the transport channel using the mixing weight, for each spatial sector,
the mixing weight being, or being derived from, a coefficient indicative of the relative directionality of the signal in the specific spatial sector over the relative directionalities of the totality of the spatial sectors.

6. The audio signal representation decoding unit of claim 2, configured to weight the at least one transport channel or sector signal derived from the transport channel for at least one first spatial sector using a first mixing weight being, or being derived from, a coefficient indicative of the sector directionality in the first spatial sector, and
configured to weight the at least one transport channel or sector signal derived from the transport channel for at least one second spatial sector using a second mixing weight,
the audio signal representation decoding unit being configured to retrieve the second mixing weight being retrieved by complementing, to a predetermined fixed value, the coefficient indicative of the sector directionality in the first spatial sector.

7. The audio signal representation decoding unit of claim 2, configured to derive each of N−1 mixing weights from parameters written in the side information, and to derive one N-th mixing weight from by complementing the other N−1 mixing weights to a constant positive value, where N is the number of spatial sectors.

8. The decoding unit of claim 1, configured, in each sector decoding path, to apply, to the at least one sector signal, the directional parameter(s) by multiplying the at least one sector signal by a vector of spherical harmonic functions evaluated along the DoA(s) in the spatial sector, so as to extend the directional signal for the spatial sector in a higher ambisonics order.

9. The decoding unit of claim 1, configured to apply a spatial filter to the at least one transport channel or processed version of the at least one transport channel, to limit the at least one transport channel to one spatial sector for each sector decoding path.

10. The decoding unit of claim 1, configured to compute at least one directional sector signal using
$${x}_{s} = {x}_{s} * Y ( {Ω}_{s} ) = [ {x}_{s} * {Y}_{00} ( Ω ) , {x}_{s} * {Y}_{1 - 1} ( Ω ) , {x}_{s} * {Y}_{10} ( Ω ) , {x}_{s} * {Y}_{11} ( Ω ) , … ] ,$$
where s indicates the spatial sector, xₛ is the transport channel, or processed version thereof, in the specific spatial sector s, Ωₛ is the directional parameter for the specific spatial sector s, and Y, which is a function of Ωₛ, is the vector of spherical harmonic functions given by [Y₀₀(Ωₛ), Y₁₋₁(Ωₛ), Y₁₀(Ωₛ), Y₁₁(Ωₛ), . . . Yₙₘ(Ωₛ)], and Yₙₘ(Ωₛ) is a spherical harmonic of order n and degree m.

11. The decoding unit of claim 1, configured to compute at least one directional sector signal for at least the specific spatial sector using
$${x}_{H , s} = ( 1 - Ψ ) * {a}_{s} * Y ( {Ω}_{s} ) * {x}_{s}$$
where Ψ is the global diffuseness parameter, aₛ is the sector diffuseness parameter expressed as relative sector directionality in the at least one sector signal, Y(Ωₛ) is a vector of spherical harmonic functions evaluated along the DoA Ωₛ in the specific spatial sector.

12. The decoding unit of claim 1, configured to read the global diffuseness parameter from the side information.

13. The decoding unit of claim 1, configured to estimate the global diffuseness parameter from the at least one transport channel.

14. The decoding unit of claim 1, configured to apply a global diffuseness weight obtained from the global diffuseness parameter, or the information on the global diffuseness of the audio signal, to weight the at least one transport channel, thereby obtaining a global diffuseness signal version to be used in the global diffuseness signal decoding path, and
to apply a second weight, complementary to the global diffuseness weight, to weight the at least one transport channel, thereby obtaining at least one globally non-diffuse signal to be processed in the plurality of sector decoding paths.

15. The decoding unit of claim 1, configured to derive mixing weight(s) of the global diffuseness signal and the directional sector signals from the global diffuseness parameter, or the information on the global diffuseness of the audio signal.

16. The decoding unit of claim 1, configured to apply, to the at least one transport channel, a weighting parameter complementary to the global diffuseness parameter used for deriving the global diffuseness signal, so that, for each sector decoding path, the at least transport channel is weighed using the weighting parameter.

17. The audio signal representation decoding unit of claim 1,
wherein the global diffuseness signal decoding path is configured to weight the at least one transport channel by a global diffuseness gain, which is, or is derived from, the global diffuseness parameter, or the other information on the global diffuseness of the audio signal, and
each of the plurality of sector decoding paths is configured to weight the at least one transport channel by a global directionality gain which is, or is derived from, the global diffuseness parameter, or the other information on the global diffuseness of the audio signal.

18. The audio signal representation decoding unit of claim 17, wherein the global diffuseness gain is 1+g(Ψ) and is according to
$$1 + g ( Ψ ) = \sqrt{1 + Ψ * ( \frac{H + 1}{L + 1} - 1 )} ,$$
where Ψ is, or is derived from, the global diffuseness parameter, or the other information on the global diffuseness of the audio signal, L is an ambisonic input order and H is an ambisonic output order.

19. The audio signal representation decoding unit of claim 17, wherein the global diffuseness gain is 1+g(Ψ) and is according to
$$1 + g ( Ψ ) = \sqrt{1 + Ψ * ( {f}_{comp} - 1 )} ,$$
where Ψ is, or is derived from, the global diffuseness parameter, or the other information on the global diffuseness of the audio signal, and f_{comp} is a diffuse compensation factor.

20. The audio signal representation decoding unit of claim 19, where the diffuse compensation factor is given by
$${f}_{comp} = \frac{( {\sum }_{l = 0}^{H} {\sum }_{m = - l}^{l} \frac{1}{2 * l + 1} )}{( {\sum }_{l = 0}^{L} {\sum }_{m = - l}^{l} \frac{1}{2 * l + 1} )}$$
where l is the degree of a spherical harmonic and L is the ambisonic order of the input signal and H is a higher ambisonic order, or a signal comprising the transport channels and channels generated via the use of decorrelators, and m is the index of a spherical harmonic and assumes values from −l to l.

21. The audio signal representation decoding unit of claim 17, where the value range of the global diffuseness gain is limited to a certain value range as to prevent too strong deviations from the global diffuseness signal.

22. The audio signal representation decoding unit of claim 17, wherein the global diffuseness signal decoding path includes an energy compensator unit to apply the gain to the global diffuseness signal to adjust the energy distribution as to obtain a more physically realistic ambisonics output signal.

23. The audio signal representation decoding unit of claim 1, configured to switch between:
a low order operation mode, in which, among the plurality of sector decoding paths, at least one of the sector decoding paths is deactivated, while only one of the sector decoding paths is activated, wherein the side information does not contain the sound field parameter(s) for the deactivated at least one of the sector decoding paths; and
a high order operation mode, in which, among the plurality of sector decoding paths, all the plurality sector decoding paths are activated, or at least less sector decoding paths are deactivated in respect to the low order operation mode, wherein the side information also contains the sound field parameter(s) for all the plurality of the sector decoding paths, as well as the global diffuseness parameter.

24. The audio signal representation decoding unit of claim 1, configured to convert the spatial audio signal representation from an encoded at least one transport channel into a decoded version of the encoded at least one transport channel.

25. The audio signal representation decoding unit of claim 24, further comprising an EVS decoder to decoder the encoded at least one transport channel into the decoded version of the encoded at least one transport channel.

26. The audio signal representation decoding unit of claim 1, configured to convert the decoded ambisonic spatial audio signal representation from the filterbank domain to the time domain.

27. The audio signal representation decoding unit of claim 1, further configured to upmix the at least one transport channel from a first number of transport channels to a second number of transport channels greater than the first number.

28. The audio signal representation decoding unit of claim 1, comprising a mixing-matrix estimator configured to process the sound field parameters, to derive a covariance matrix, or other covariance information, between different transport channels, the mixing-matrix estimator being configured to reconstruct a mixing matrix, or other mixing information, from the covariance matrix, or the other covariance information, and to apply the mixing matrix, or the other mixing information, to the transport channels.

29. The audio signal representation decoding unit of claim 28, wherein the covariance-matrix synthesizer is configured to process the sound field parameter(s) including the DoA parameter(s) and sector diffuseness parameter(s) of the plurality of spatial sectors and the global diffuseness parameter, or other information on the global diffuseness, to derive the covariance matrix, or the other covariance information, between different transport channels, the mixing-matrix estimator being configured to reconstruct a mixing matrix, or the other mixing information, from the covariance matrix, or the other covariance information, so as to employ the sound field parameter(s) to derive the covariance matrix, or the other covariance information, for at least one frequency band, the audio signal representation decoding unit being configured to derive the covariance matrix, or the other covariance information, for at least one other frequency band without using the sound field parameters.

30. The audio signal representation decoding unit of claim 29, configured to derive, for at least one other frequency band, the mixing matrix, or other mixing information, from covariance information which is received from the side information.

31. The audio signal representation decoding unit of claim 24, where the sound field parameters are modified in order to achieve a rotation of the sound field represented by the output ambisonic signal.

32. An apparatus, comprising:
the audio signal representation decoding unit of claim 1;
a bitstream reader and dequantizer, configured to read a bitstream, in which there is encoded the low order spatial audio signal representation, and to provide the high order spatial audio signal representation to the audio signal representation decoding unit.

33. The apparatus of claim 32, further comprising
a renderer, to render the audio signal from the ambisonic spatial audio signal representation.

34. The apparatus of claim 32, further comprising an encoding unit to encode the high order spatial audio signal representation onto a second spatial audio signal representation.

35. An audio signal representation encoding unit for encoding an input spatial audio signal representation, representing an audio signal, onto a compressed ambisonic spatial audio signal representation representing the audio signal,
the audio signal representation encoding unit being configured to downmix the input spatial audio signal representation to derive at least one transport channel;
the audio signal representation encoding unit being configured to derive side information, the side information including sound field parameters, the sound field parameters including, for each spatial sector of a plurality of spatial sectors, directional parameter(s) providing information on a direction of arrival, DoA, in the spatial sector, the sound field parameters including sector diffuseness parameter(s) providing information on diffuseness of the audio signal in at least one spatial sector,
the audio signal representation encoding unit including a plurality of sector parameter estimators, each sector parameter estimator being configured to process a specific sector signal of the input spatial audio signal representation in a specific spatial sector of the plurality of spatial sectors, so as to derive the directional parameter(s) and the information on diffuseness of the audio signal in the at least one spatial sector,
the audio signal representation encoding unit including a bitstream writer to encode the at least one transport channel and the side information.

36. The audio signal representation encoding unit of claim 35, further including a global diffuseness parameter estimator to estimate a global diffuseness parameter to be inserted in the side information.

37. The audio signal representation encoding unit of claim 35, configured to refrain from writing, in the bitstream, a global diffuseness parameter.

38. The audio signal representation encoding unit of claim 35, further configured to estimate a relative directionality of each specific spatial sector in respect to the directionalities of the all spatial sectors, and to write the coefficient, or information indicative of the relative directionality, as a sector diffuseness parameter.

39. The audio signal representation encoding unit of claim 38, further configured to estimate the relative directionality as including at least one of a first and a second spatial sector respectively indicated with a₁ and a₂ and satisfies
$${a}_{1} = \frac{1 - {Ψ}_{1}}{( 1 - {Ψ}_{1} ) + ( 1 - {Ψ}_{2} )} and$$
$${a}_{2} = 1 - {a}_{1} ,$$
where Ψ₁ is, or is obtained from, the sector diffuseness information for the first spatial sector and Ψ₂ is, or is obtained from, the sector diffuseness information for the second spatial sector.

40. The audio signal representation encoding unit of claim 38, further configured to estimate the relative directionality to include two or more sectors according to
$${a}_{i} = \frac{1 - {Ψ}_{i}}{{\sum }_{j} ( 1 - {Ψ}_{i} )} with$$
$${\sum }_{j} {a}_{j} = 1 ,$$
where i indicates the i-th, specific, spatial sector, and j indicates a generic j-th spatial sector of the plurality of spatial sectors, Ψᵢ and Ψⱼ indicate the sector diffuseness information for the i-th, specific, spatial sector, and each j-th generic spatial sector.

41. The audio signal representation encoding unit of claim 35, configured to perform an active downmix of the audio signal, or a processed version thereof, using a downmix matrix, or other downmix information, computed by a downmix information calculator, the downmix information calculator being configured to process the sound field parameter(s) to derive the downmix matrix, or other downmix information, based on the global diffuseness parameter and sector diffuseness parameter(s) and directional parameter(s) for each spatial sector of the plurality of spatial sector.

42. The audio signal representation encoding unit of claim 41, wherein the information matrix calculator is configured to perform an inter-channel prediction to derive the downmix matrix, or other downmix information, based on an inter channel covariance matrix, or other inter channel covariance information, the inter channel covariance matrix or other inter channel covariance information being derived from the directional parameter(s) and sector diffuseness parameter(s) for each spatial sector of the plurality of sectors and a global diffuseness.

43. The audio signal representation encoding unit of claim 42, the inter channel covariance matrix C being defined as having the element C_{lm,l′m′} between the ambisonic channel with the degree and index l and l′, respectively, and the ambisonic channel with the degree and index l′ and m′, respectively, and being computed according to
$${C}_{l m , {l}^{′} {m}^{′}} = ( 1 - Ψ ) * {E}_{x} * {a}^{2} * {Y}_{l m} ( {Ω}_{1} ) * {Y}_{{l}^{′} {m}^{′}} ( {Ω}_{1} ) + ( 1 - Ψ ) * {E}_{x} * {( 1 - a )}^{2} * {Y}_{l m} ( {Ω}_{2} ) * {Y}_{{l}^{′} {m}^{′}} ( {Ω}_{2} ) ++ Ψ * {σ}^{2} * {E}_{x} * {δ}_{l m , {l}^{′} {m}^{′}}$$
where Eₓ is the signal energy, δ_{lm,l′m′} is the Kronecker delta being 1 at the diagonal of the inter channel covariance matrix and 0 outside the diagonal of the inter channel covariance matrix, Ω₁ and Ω₂ are the first and second directional parameters, respectively, and “a” is a relative directionality, or another parameter indicative of a ratio, or another information on relationship, between the directionality in the spatial sector over the total directionalities of the totality of the spatial sectors, Ψ is indicative of the global diffuseness parameter, and o is an energy scaling factor.

44. The audio signal representation encoding unit of claim 38, wherein the inter-channel covariance matrix or other inter-channel covariance information is based on an energy weighted by the spherical harmonics evaluated at the DoAs (Ω₁, Ω₂, . . . , Ω_{N}) and mixing weights (a₁, a₂, . . . , a_{N}) for each spatial sector.

45. The audio signal representation encoding unit of claim 35, further configured to convert the input spatial audio signal representation into the filterbank domain to derive a filterbank version of the input spatial audio signal representation,
further configured to downmix the filterbank domain version of the input spatial audio signal representation to derive the at least one transport channel in the filterbank domain, and
further configured to perform a filterbank synthesis of the at least one transport channel from the filterbank domain to the time domain.

46. The audio signal representation encoding unit of claim 35, configured to downmix the input spatial audio signal representation using a channel selector to derive the at least one transport channel by selecting lower order channels from higher order channels of the input spatial audio signal representation.

47. The audio signal representation encoding unit of claim 35, further configured to perform an enhanced voice services, EVS, encoding, so as to provide an EVS-encoded version of the at least one transport channel.

48. The audio signal representation encoding unit of claim 35 configured to switch between:
a low order operation mode, in which, among a plurality of sector paths, at least one of the sector paths is deactivated, while only one of the sector paths is activated, wherein the side information does not contain the sound field parameter(s) for the deactivated at least one of the sector paths; and
a high order operation mode, in which, among the plurality of sector paths, all the plurality sector paths are activated, or at least less sector paths are deactivated in respect to the low order operation mode, wherein the side information also contains the sound field parameter(s) for all the plurality of the activated sector paths, as well as a global diffuseness parameter.

49. The audio signal representation encoding unit of claim 48, configured to select between the low order operation mode and the high order operation mode based on the bitrate, so as to select the low order operation mode in case of low bitrate, and the high order operation mode in case of bitrate higher than the low bitrate.

50. The audio signal representation encoding unit of claim 48, configured to select between the low order operation mode and the high order operation mode based on measurements related to the quality of the network connection, so that:
in case the measurements related to the quality of the network connection are indicative of low quality, the audio signal representation encoding unit selects the low order operation mode, and,
in case the measurements related to the quality of the network connection are indicative of quality higher than the low quality, the audio signal representation encoding unit selects the high order operation mode.

51. The audio signal representation encoding unit of claim 48, configured to select between the low order operation mode and the high order operation mode based on battery-supply-related measurements, so that:
in case the battery-supply-related measurements are indicative of low battery supply of a battery supplying the audio signal representation encoding unit, the audio signal representation encoding unit selects the low order operation mode, and,
in case the battery-supply-related measurements are indicative of battery supply higher than the low battery supply, the audio signal representation encoding unit selects the high order operation mode.

52. The audio signal representation encoding unit of claim 48, configured to select between the low order operation mode and the high order operation mode based on a feedback signal from a receiver (e.g. decoding unit), so to select the operating mode requested in the feedback signal.

53. An audio encoder comprising:
the audio signal representation encoding unit of claim 35;
a quantizer and bitstream writer for writing, in a bitstream, a low order spatial audio signal representation and/or the compressed ambisonic spatial audio signal representation.

54. A method for decompressing an ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the method including using a plurality of sector decoding paths, each sector decoding path decoding a directional sector signal of the ambisonic spatial audio signal representation in each spatial sector by applying, to the at least one transport channel, or a sector signal derived from the transport channel, the directional parameter(s) and the sector diffuseness parameter(s) of the spatial sector,
the method including using a global diffuseness signal decoding path to derive a global diffuseness signal by applying, to the at least one transport channel, a global diffuseness parameter, or other information on the global diffuseness of the audio signal,
the method including combining, through a global diffuseness signal inserter, the plurality of decoded directional sector signals and the global diffuseness signal, to output the decompressed ambisonic spatial audio signal representation.

55. A method for encoding an input spatial audio signal representation, representing an audio signal, onto a compressed ambisonic spatial audio signal representation representing the audio signal,
the method including deriving at least one transport channel and side information, the side information including sound field parameters, the sound field parameters including, for each spatial sector of a plurality of spatial sectors, directional parameter(s) providing information on a direction of arrival, DoA, in the specific spatial sector, the sound field parameters including sector diffuseness parameter(s) providing information on diffuseness of the audio signal in at least one spatial sector,
the method including using a plurality of sector parameter estimators, each sector parameter estimator processing a specific sector signal of the input spatial audio signal representation in a specific spatial sector of the plurality of spatial sectors, so as to derive the directional parameter(s) and the information on diffuseness of the audio signal in the at least one spatial sector,
the method including using an encoding of the at least one transport channel and the side information into a bitstream.

56. A non-transitory digital storage medium having a computer program stored thereon to perform the method for decompressing an ambisonic spatial audio signal representation representing an audio signal, the compressed ambisonic spatial audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector,
the method including using a plurality of sector decoding paths, each sector decoding path decoding a directional sector signal of the ambisonic spatial audio signal representation in each spatial sector by applying, to the at least one transport channel, or a sector signal derived from the transport channel, the directional parameter(s) and the sector diffuseness parameter(s) of the spatial sector,
the method including using a global diffuseness signal decoding path to derive a global diffuseness signal by applying, to the at least one transport channel, a global diffuseness parameter, or other information on the global diffuseness of the audio signal,
the method including combining, through a global diffuseness signal inserter, the plurality of decoded directional sector signals and the global diffuseness signal, to output the decompressed ambisonic spatial audio signal representation,
when said computer program is run by a computer.

57. A non-transitory digital storage medium having a computer program stored thereon to perform the method for encoding an input spatial audio signal representation, representing an audio signal, onto a compressed ambisonic spatial audio signal representation representing the audio signal,
the method including deriving at least one transport channel and side information, the side information including sound field parameters, the sound field parameters including, for each spatial sector of a plurality of spatial sectors, directional parameter(s) providing information on a direction of arrival, DoA, in the specific spatial sector, the sound field parameters including sector diffuseness parameter(s) providing information on diffuseness of the audio signal in at least one spatial sector,
the method including using a plurality of sector parameter estimators, each sector parameter estimator processing a specific sector signal of the input spatial audio signal representation in a specific spatial sector of the plurality of spatial sectors, so as to derive the directional parameter(s) and the information on diffuseness of the audio signal in the at least one spatial sector,
the method including using an encoding of the at least one transport channel and the side information into a bitstream,
when said computer program is run by a computer.

58. A compressed ambisonic audio signal representation including at least one transport channel and side information, the side information including sound field parameters, the sound field parameters including, for each spatial sector of a plurality of spatial sectors, directional parameter(s) providing information on a direction of arrival, DoA, in the spatial sector, the sound field parameters including, for at least one spatial sector, sector diffuseness parameter(s) providing information on sector diffuseness of the audio signal in the at least one spatial sector, and a global diffuseness parameter.
